(19) United States
(12) Patent Application Publication
(10) Pub. No.: US 2009/0108727 A1
(43) Pub. Date: Apr. 30, 2009

(54) ELECTRON-EMITTING DEVICE, ELECTRON SOURCE, IMAGE DISPLAY APPARATUS, AND MANUFACTURING METHOD OF ELECTRON-EMITTING DEVICE

(75) Inventors: Kazushi Nomura, Sagamihara-shi (JP); Ryoji Fujiwara, Chigasaki-shi (JP); Michiyo Nishimura, Sagamihara-shi (JP); Yoji Teramoto, Ebina-shi (JP); Shunsuke Murakami, Atsugi-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/255,185

(22) Filed: Oct. 21, 2008

(30) Foreign Application Priority Data
Oct. 29, 2007 (JP) 2007-280201

(51) Int. Cl. H01J 1/00; H01J 9/02

(52) U.S. Cl. 313/310; 445/51

(57) ABSTRACT

An electron-emitting device according to the present invention is characterized by that a gate electrode is located above a cathode electrode; a insulating member is located between the gate electrode and the cathode electrode; and the gate electrode and the insulating member are provided with openings, respectively, the openings being communicated with each other, wherein the insulating member is formed by layering three or more insulating layers including a first insulating layer, which is brought in contact with the gate electrode and has an opening, of which size is approximately the same as the size of the opening of the gate electrode; and a second insulating layer, which is located nearer to the side of the cathode electrode than the first insulating layer and has a larger opening than the opening of the gate electrode.

### BACKGROUND OF THE INVENTION

1. Field of the invention

The present invention relates to an electron-emitting device and a manufacturing method thereof, and further, the present invention relates to an electron source and an image display apparatus using the electron-emitting device.

2. Description of the Related Art

Conventionally, there has been an electron-emitting device, which is provided with an insulating layer between a cathode electrode and a gate electrode and has openings that are communicated with each other at the gate electrode and the insulating layer, respectively. An electron-emitting member in such an electron-emitting device is formed on the cathode electrode, and at least a part thereof is exposed within the openings of the gate electrode and the insulating layer.

As an example of such an electron-emitting device, there is an electron-emitting device having an electron-emitting member, which having a conical or tubular projection having a small curvature at its front end on the cathode electrode or an electron-emitting member, which is approximately flat and can emit electrons in a low electric field on the cathode electrode. According to the electron-emitting device having an electron-emitting member, which having the conical or tubular projection having a small curvature at its front end on the cathode electrode, emission of electrons is made selectively from the front end portion of this projection.

Compared to the above-described electron-emitting device, having an electron-emitting member, which having the conical or tubular projection having a small curvature at its front end, the electron-emitting device, having the electron-emitting member, which is approximately flat and can emit electrons in a low electric field on the cathode electrode, is more expected to be one excellent in a focusing capability of an electron beam.

For the electron-emitting device, having the electron-emitting member, which is approximately flat and can emit electrons in a low electric field on the cathode electrode, there is a method of improving a focusing capability of an electron beam by changing the shape of the cathode electrode. Such an art is disclosed in Japanese Patent Application Laid-Open (JP-A) No. 8-115654, Japanese Patent Application Laid-Open (JP-A) No. 8-293244, Japanese Patent Application Laid-Open (JP-A) No. 10-125215, Japanese Patent Application Laid-Open (JP-A) No. 2000-67736, the specification of U.S. Pat. No. 5,473,218, and Japanese Patent Application Laid-Open (JP-A) No. 8-55564, for example.

FIG. 15 shows an example, which is disclosed in JP-A No. 8-115654. In this configuration, an electron-emitting surface (namely, a surface where electrons are emitted in an electron-emitting member) is located deeper than a surface of an insulating layer side of a cathode electrode layer within a micropore.

In FIG. 15, an electron-emitting device is configured by a cathode electrode layer 32, an insulating layer 15, and a gate electrode layer 14 on a substrate 11, and an electron-emitting member 16 is arranged on a bottom surface within a micropore 20 (namely, an electron-emitting surface). In order to locate the surface (the electron-emitting surface) of the electron-emitting member 16 deeper than a boundary face between the cathode electrode layer 32 and the insulating layer 15, a groove is formed in the cathode electrode layer 32.

FIG. 16 shows an example, which is disclosed in JP-A No. 8-55564. In this configuration, a cathode electrode 35 is provided on an electron-emitting film 34.

In addition, there has been a technique to make a diameter of an electron beam smaller by devising not an electrode configuration but a potential distribution within the opening.

FIG. 17 shows an example, which is disclosed in Japanese Patent Application Laid-Open (JP-A) No. 2002-536802. In this configuration, two insulating layers having different dielectric constants are provided.

FIG. 18 shows an example, which is disclosed in Japanese Patent Application Laid-Open (JP-A) No. 2000-156147. In this configuration, the diameter of the opening is devised (the diameter of the opening is made gradually larger from the surface of the cathode electrode toward the side of the gate electrode).

As described above, the electron-emitting device excellent in a focusing capability has been developed. In addition, a high-definition image display apparatus has been developed in such a manner that an electron source is manufactured by arranging a number of these electron-emitting devices on a flat substrate, and thereby, an image display apparatus is manufactured

A good electric property is needed for the electron-emitting device, so that generation of a reactive current, namely, a leak current between the cathode electrode and the gate electrode becomes a problem.

As a cause of generation of the leak current in the opening, a residue remaining after a manufacturing step may be considered. As a residue, there are attachment of a particle (an electrode material and an electron-emitting member) and a secondary generated substance in an etching step (a side-wall product due to dry etching) or the like. These residues are desired to be removed as much as possible.

In addition, the electron-emitting device is expected to be capable of being driven stably for a long period of time.

Stability in driving is also effected by the residue. In the case where the residue is a particle, the particle may be charged by a strong electric field within the opening and the particle may be moved. Thereby, discharge may occur. Even if excessive increase of temperature is temporarily generated due to discharge, the opening is deformed.

In order to prevent such deformation, a configuration such that the opening is hardly deformed is desirable. For example, it is necessary to select a configuration and a material which are tolerant of temperature change and to improve adhesiveness between each layer.

In addition, in the case where the residue is a conductive attachment, the potential distribution within the opening is curved by this attachment. The curve of the potential distribution has a possibility to cause unnecessary incidence of electrons into a side wall portion (an insulating layer). A charging phenomenon of the insulating layer due to incidence of electrons may decrease a dielectric strength voltage between the gate electrode and the cathode electrode.

As a method to increase the dielectric strength voltage, a method to make a creeping distance between the gate electrode and the cathode electrode longer or the like may be considered.

In addition, even in the case of a good electron-emitting device having no leak current, its electron emission characteristic is lowered since the emitted electron ionizes a surrounding gas. There is an example such that the opening is devised in order to prevent this.

FIG. 19 and FIG. 20 show an example, which is disclosed in Japanese Patent Application Laid-Open (JP-A) No. 10-308163. This example shows the configuration such that the side wall configuration is devised to realize a long-term stability of an electron-emitting device. This electron-emitting device is configured in such a manner that a curvature is provided at a front end of an electron-emitting member and a lower side of an insulating layer went back to a rear part (an outside) for the opening.

In this way, it is important that the interior of the opening is configured such that the residue remaining after the manufacturing step has been removed and change of the potential distribution within the opening is prevented or the like.

### SUMMARY OF THE INVENTION

The present invention has been made in order to solve the above-described problems of the conventional art and an object of the present invention is to provide an electron-emitting device having a configuration such that a focusing property of an electron beam is excellent, a leak current is prevented, and deformation hardly occurs.

In addition, a further object of the present invention is to provide an electron source using such an electron-emitting device and a high-definition image display apparatus, which can realize a high image quality by utilizing this electron source.

An electron-emitting device according to the present invention is characterized by comprising a cathode electrode, a gate electrode, an insulating member, and an electron-emitting member; wherein the gate electrode is located above the cathode electrode; the insulating member is located between the gate lectrode and the cathode electrode; the gate electrode and the insulating member are provided with openings, respectively, the openings being communicated with each other; and the electron-emitting member is provided on the cathode electrode, and at least a part of the electron-emitting member is exposed within the openings of the gate electrode and the insulating member, wherein the insulating member is formed by layering three or more insulating layers including a first insulating layer, which is brought in contact with the gate electrode and has an opening, of which size is approximately the same as the size of the opening of the gate electrode; and a second insulating layer, which is located nearer to the side of the cathode electrode than the first insulating layer and has a larger opening than the opening of the gate electrode.

In addition, a manufacturing method of an electron-emitting device according to the present invention is characterized by the electron-emitting device comprising a cathode electrode, a gate electrode, an insulating member, and an electron-emitting member; wherein the gate electrode is located above the cathode electrode; the insulating member is located between the gate electrode and the cathode electrode; the gate electrode and the insulating member are provided with openings, respectively, the openings being communicated with each other; and the electron-emitting member is provided on the cathode electrode, and at least a part of the electron-emitting member is exposed within the openings of the gate electrode and the insulating member; the manufacturing method comprising a first step of forming the insulating member by layering three or more insulating layers including a first insulating layer, which is brought in contact with the gate electrode; and a second insulating layer, which is located nearer to the side of the cathode electrode than the first insulating layer; and a second step of making the opening of the second insulating layer larger than the opening of the gate electrode.

In addition, an electron source according to the present invention is characterized by comprising a plurality of the electron-emitting devices according to the present invention.

In addition, an image display apparatus according to the present invention is characterized by comprising the electron source according to the present invention; and an image forming member for forming an image by electrons that are emitted from the electron source.

According to the present invention, it is possible to provide an electron-emitting device having a configuration such that a focusing property of an electron beam is excellent, a leak current is prevented, and deformation hardly occurs.

Further, it is possible to provide an electron source using such an electron-emitting device and a high-definition image display apparatus, which can realize a high image quality by utilizing this electron source.

Further features of the present invention will become apparent from the following description of exemplary embodiments with reference to the attached drawings.

### BRIEF DESCRIPTION OF THE DRAWINGS

FIG. 1A is a plan view showing a configuration of an electron-emitting device according to an embodiment of the present invention;

FIG. 1B is a sectional view taken on a line A-A′ in FIG. 1A;

FIG. 2 is a view showing the details of a driving state of the electron-emitting device shown in FIG. 1A and FIG. 1B;

FIG. 3A to FIG. 3F are views showing an example of a manufacturing method of the electron-emitting device shown in FIG. 1 and FIG. 1B;

FIG. 4 is a view showing an example of an electron source according to the embodiment of the present invention;

FIG. 5 is a view showing an example of the electron source according to the embodiment of the present invention;

FIG. 6 is a view showing an example of the image display apparatus according to the embodiment of the present invention;

FIG. 7A is a schematic view of a phosphor film of the image display apparatus according to the embodiment of the present invention;

FIG. 7B is a schematic view of the phosphor film of the image display apparatus according to the embodiment of the present invention;

FIG. 8 is a block diagram showing an example of a driving circuit of the image display apparatus according to the embodiment of the present invention;

FIG. 9A and FIG. 9B are views showing an electron-emitting device according to a second example;

FIG. 10A to FIG. 10F are views showing a manufacturing method of the electron-emitting device according to the second example;

FIG. 11 is a view showing an electron-emitting device according to a third example;

FIG. 12 is a view showing an electron-emitting device according to a forth example;

FIG. 13 is a view showing an electron-emitting device according to a fifth example;

FIG. 14 is a view showing an electron-emitting device according to a sixth example;

FIG. 15 is a view schematically showing a conventional electron-emitting device;

FIG. 16 is a view schematically showing the conventional electron-emitting device;

FIG. 17 is a view schematically showing the conventional electron-emitting device;

FIG. 18 is a view schematically showing the conventional electron-emitting device;

FIG. 19 is a view schematically showing the conventional electron-emitting device; and

FIG. 20 is a view schematically showing the conventional electron-emitting device.

### DESCRIPTION OF THE EMBODIMENTS

With reference to the drawings, preferable embodiments of this invention will be described with an example in detail below. However, a scope of this invention is not limited to a measurement, a material, a shape, and its relative arrangement or the like of a constituent part described in this embodiment unless there is a description in particular. In addition, a scope of this invention is not limited to a condition such as a voltage to be applied to a cathode electrode, a gate electrode, and an anode electrode and a driving waveform unless there is a description in particular.

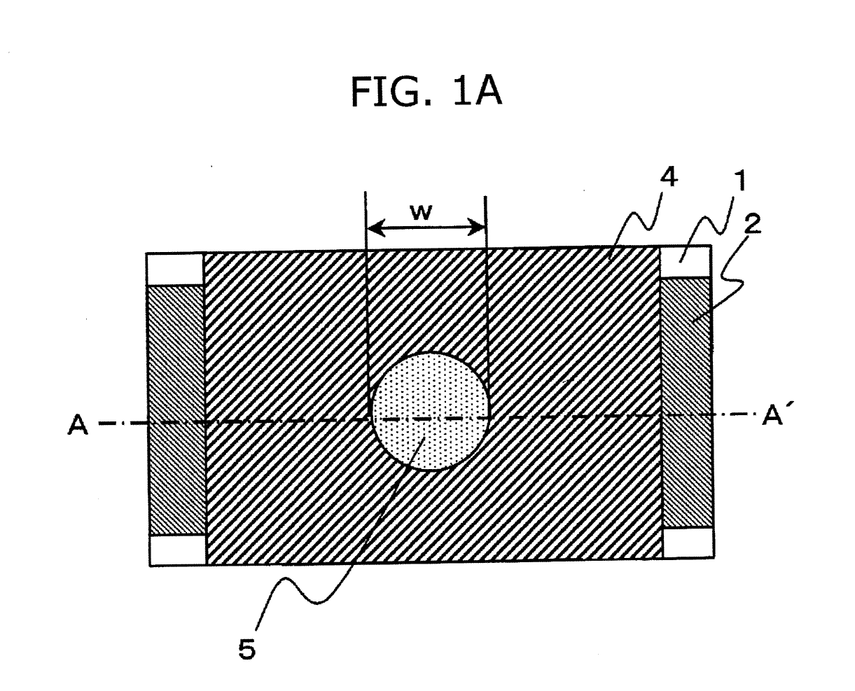

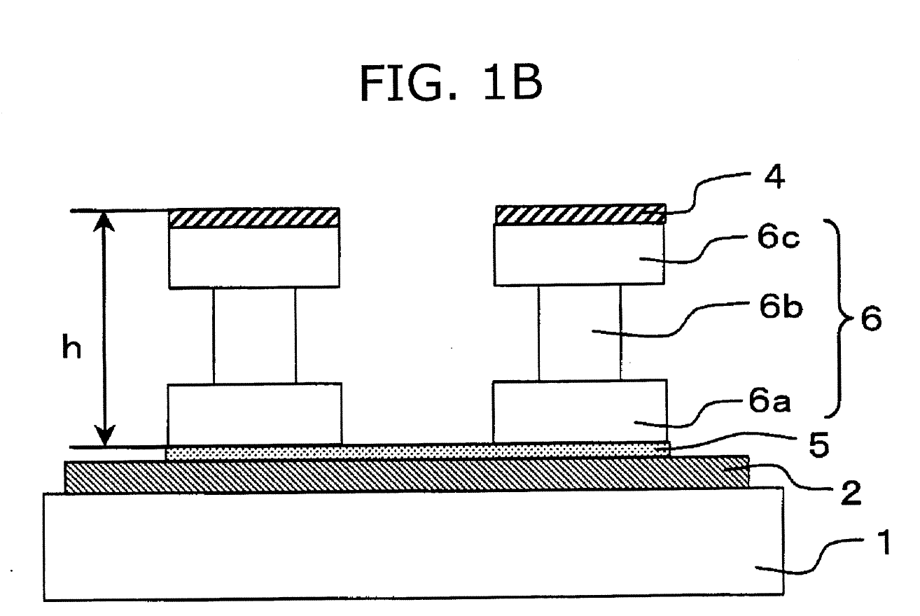

With reference to FIGS. 1A to 3, an electron-emitting device according to the embodiment of the present invention will be described.

FIGS. 1A and 1B are schematic views showing a configuration of an electron-emitting device according to the present embodiment. FIG. 1A is a plan view. FIG. 1B is a sectional view taken on a line A-A′ in FIG. 1A (the section is obtained by a flat surface that is vertical to a gate electrode and passes through centers of openings of the gate electrode and an insulating member, and hereinafter, “a section” means this section).

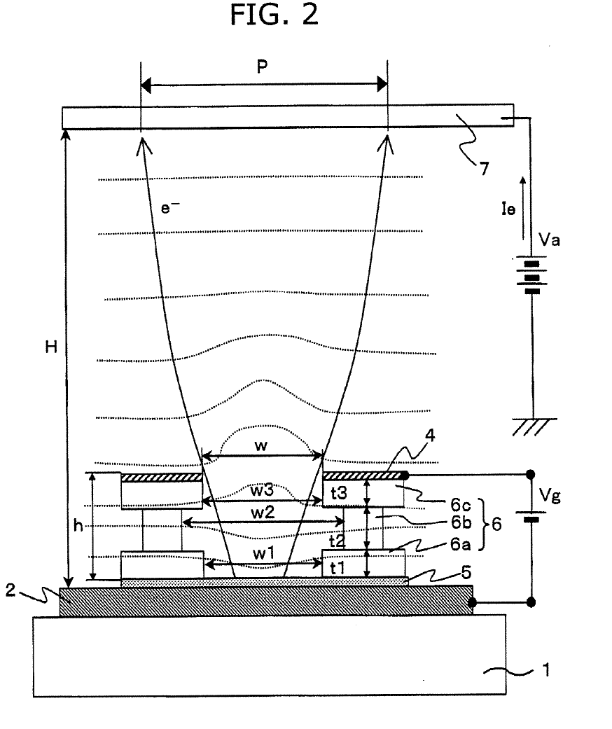

FIG. 2 is a view showing the details of a driving state of the electron-emitting device shown in FIG. 1A and FIG. 1B.

In FIGS. 1A, 1B, and 2, a reference numeral 1 denotes a substrate, a reference numeral 2 denotes a cathode electrode, a reference numeral 4 denotes a gate electrode, a reference numeral 5 denotes an electron-emitting member, and a reference numeral 6 denotes an insulating member. Here, the gate electrode 4 is located above the cathode electrode. The insulating member 6 is located between the gate electrode 4 and the cathode electrode 2. The gate electrode 4 and the insulating member 6 are provided with openings, respectively, the openings being communicated with each other. The electron-emitting member 5 is provided on the cathode electrode, and at least a part thereof is exposed within the openings of the gate electrode 4 and the insulating layer 6. Further, it is preferable that the openings to be formed in the gate electrode 4 and the insulating layer 6, respectively, are communicated with each other in a concentric fashion.

The insulating member 6 is formed by layering three and more insulating layers including a first insulating layer and a second insulating layer. The first insulating layer is brought in contact with the gate electrode and has an opening of substantially the same size as an opening of the gate electrode. The second insulating layer is located nearer to the side of the cathode electrode than the first insulating layer and has an opening that is larger than the opening of the gate electrode. According to the examples shown in FIGS. 1A and 1B, the insulating member 6 is formed by three insulating layers (insulating layers 6a to 6c). The insulating layer 6c brought in contact with the gate electrode 4 is defined as the first insulating layer, and the insulating layer 6b located in midway (between the insulating layer 6a and the insulating layer 6c) is defined as the second insulating layer.

A driving voltage Vg is applied between the cathode electrode 2 and the gate electrode 4.

A reference numeral 7 denotes an anode electrode that is arranged above the electron-emitting device apart at a distance H. An anode voltage Va is applied to the anode electrode 7. Normally, the distance H is a distance, which is based on the position of the cathode electrode 2.

In the anode electrode 7, electrons are added thereto and an electron-emitting current Ie is detected.

If the driving voltage Vg is applied, a gate current Ig passes through between the cathode electrode and the gate electrode. The gate current Ig has two types, namely, one type passes via a conductive path of a circumference of an opening (the side wall of the opening and the interior of the insulating member), which is formed so as to be communicated with each of the gate electrode 4 and the insulating member 6 and other type passes when the electrons emitted from the electron-emitting member 5 into vacuum reenter the gate electrode 4. Any of the gate currents Ig is a current that does not reach the anode electrode 7 and becomes a reactive current.

An efficiency of the electron-emitting device (an electron emission efficiency) can be defined as follows:

an electron emission efficiency=an electron current/all currents=Ie/(Ig+Ie)

where, in the group consisting of all currents to pass by applying the driving voltage Vg (all currents), a current to reach the anode electrode (an electron current) is defined as Ie and a current not to reach the anode electrode (a reactive current) is defined as Ig.

In other words, the smaller the gate current Ig between the cathode electrode and the gate electrode is, the higher the electron emission efficiency is. In addition, if there is no leak current and no electron enters the gate electrode, the electron emission efficiency becomes 1 and it is ideal.

As described above, each of the gate electrode 4 and the insulating member 6 has the openings to be communicated with each other. Any shapes of the openings may be available. Specifically, a circular shape, a polygonal shape, and a rectangle shape or the like may be adopted (further, in the case where the shape of the opening is other than the circle, it is preferable that the openings of the gate electrode 4 and the insulating member 6 are concentric with each other and the directions of the shapes are substantially the same).

In the case where the opening has the circular shape, generally, a diameter of the opening is represented by “w” and a depth of the opening is represented by “h”.

In the case where the opening has the polygonal shape, it is general that a diameter of a circumscribed circle is defined as a diameter of the opening w, and in the case where the opening has the rectangle shape, it is general that a length of a narrow side is defined as a diameter of the opening w (a length of a long side is distinguished as a width of an opening).

A dotted line in FIG. 2 shows an equipotential plane when this electron-emitting device is driven. Although the shape of the equipotential plane is varied depending on a driving condition, the dotted line in FIG. 2 is an equipotential plane when the electron-emitting device according to the present embodiment is driven under a general driving condition.

In the electron-emitting device according to the present embodiment, by making the equipotential plane just above the electron-emitting member 5 (on the side of the gate electrode) into a concave equipotential plane in a sectional view (on the side of the cathode electrode) as shown in FIG. 2, it is possible to manufacture an electron-emitting configuration, which is excellent in a focusing capability.

On the other hand, the equipotential plane in the vicinity of the opening of the gate electrode 4 becomes a convex form that swells (to the side of the gate electrode) at a center part. Accordingly, the electrons are emitted so as to be wider to the outside than the opening of the gate electrode and the electrons reach the anode electrode as shown in FIG. 2.

In order to obtain such an equipotential plane, there is a plurality of methods.

According to one method, a shape of an insulating layer and a dielectric constant of the insulating layer are devised, and the configuration of the electron-emitting device shown in FIGS. 1A and 1B is an example that both of the shape and the dielectric constant of the insulating layer are devised. In other words, the electron-emitting device shown in FIGS. 1A and 1B is provided with a second insulating layer in order to obtain an equipotential plane as shown in FIG. 2. How to devise in order to obtain an equipotential plane as shown in FIG. 2 will be described later in detail.

In addition, according to other method, in order to make a potential at the end of an exposed area (an area that is exposed) of an electron-emitting member higher than a potential at a center of the exposed area of the electron-emitting member, the shape and the configuration of the cathode electrode are devised. This will be also described later.

In order to make an electron-emitting device into an effective electron-emitting device (namely, an electron-emitting device that is excellent in a focusing capability) in the present embodiment, it is necessary to prevent that the emitted electrons collide with the gate electrode 4 and the insulating member 6. If the electrons collide with the gate electrode, some of the collided electrons are emitted again. These electrons are made into electron beams having different electron orbits and reach the anode electrode. Although the amount of reach of such an electron is small, the reaching position is located outside of the reaching position of the electron that does not collide the gate electrode but reaches the anode electrode. In other words, this electron-emitting device becomes one having a low focusing capability.

The beam diameter of the electron that reaches the anode electrode becomes a beam diameter that integrates the emitted electrons (for example, a beam diameter is represented by “P” of FIG. 2).

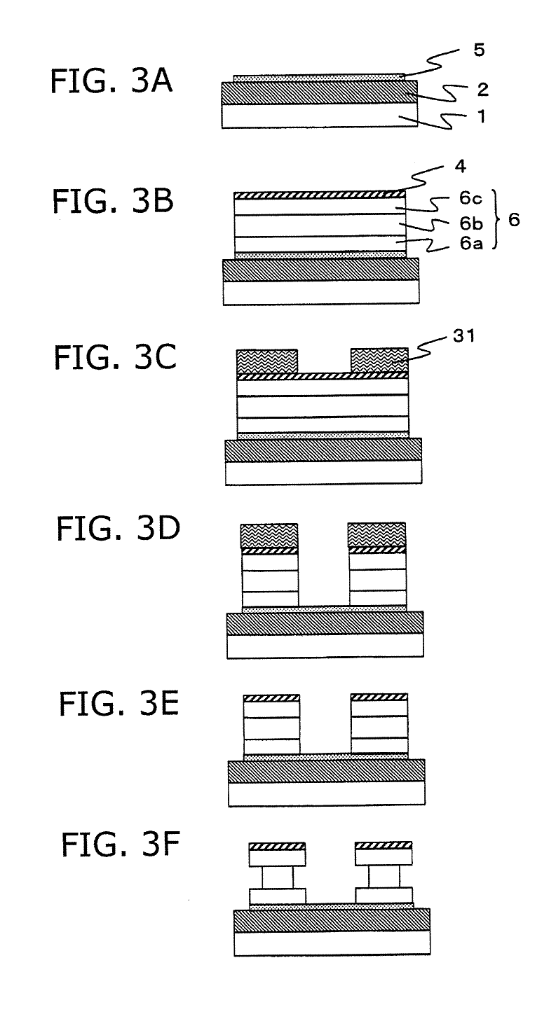

FIGS. 3A to 3F are views showing an example of a manufacturing method of an electron-emitting device according to the present embodiment shown in FIG. 1.

With reference to FIGS. 3A to 3F, an example of the manufacturing method of the electron-emitting device according to the present embodiment will be described below.

At first, as shown in FIG. 3A, the cathode electrode 2 is layered on the substrate 1. As the substrate 1, a quartz glass, a glass having a contained amount of impurity such as Na reduced, a Soda-lime glass, a silicon substrate, a laminated body having SiO₂ laminated on the silicone substrate or the like by a sputtering method or the like, and an insulating substrate made of a ceramics such as alumina or the like can be used. In addition, it is desirable that the surface of the substrate 1 is sufficiently cleaned.

Generally, the cathode electrode 2 has a conductive property and is formed by a general vacuum film formation technique such as an evaporation method and a sputtering method, and a photolithography technique. A material of the cathode electrode 2 is accordingly selected from the group consisting of a metal, an alloy metal, carbide, a boride, a nitride, a semiconductor, an organic polymer material, an amorphous carbon, graphite, a diamond-like carbon, a carbon having diamond dispersed therein, and a carbon composition or the like. As a metal, for example, Be, Mg, Ti, Zr, Hf, V, Nb, Ta, Mo, W, Al, Cu, Ni, Cr, Au, Pt, and Pd or the like may be used, and an alloy metal formed by using these metals is available. As carbide, TiC, ZrC, HfC, TaC, SiC, and WC or the like may be used. As a boride, HfB₂, ZrB₂, LaB₆, CeB₆, YB₄, and GdB₄ or the like may be used. As nitride, TiN, ZrN, and HfN or the like may be used. Then, as a semiconductor, Si and Ge or the like may be used. A thickness of the cathode electrode 2 is determined in the range of several ten nm to several mm, and preferably, the thickness of the cathode electrode 2 is selected from the range of several hundred nm to several μm.

In addition, a part of the insulating silicon substrate may have a conductive property by doping and this part may be used as the cathode electrode 2. Further, the cathode electrode 2 may have a multilayered structure having layers of different composition. In this case, as a part of the cathode electrode 2, a high resistor may be layered.

Next, on the cathode electrode, an electron-emitting member 5 is formed (layered) (FIG. 3A).

The electron-emitting member 5 is formed by a general film formation technique or the like such as an evaporation method, a sputtering method, and a plasma CVD method or the like. A material of the electron-emitting member 5 is preferably selected from the group consisting of the materials of a low work function. For example, the material of the electron-emitting member 5 is accordingly selected from the group consisting of an amorphous carbon, graphite, a diamond-like carbon, a carbon having diamond dispersed therein, and a carbon composition or the like.

A thickness of the electron-emitting member 5 is determined in the range of several nm to several hundred nm, and preferably, the thickness of the electron-emitting member 5 is selected from the range of several nm to several ten nm.

The electron-emitting member 5 is needed to be electrically connected to the cathode electrode 2 and it is desirable that the electron-emitting member 5 has a conductive property. For example, if the electron-emitting member 5 is an insulating material, it is necessary to give a conductive property thereto by doping. In addition, the electron-emitting member 5 itself may have a conductive property.

After that, the insulating member 6 (the insulating layers 6a to 6c) and the gate electrode 4 are accumulated in series (FIG. 3B).

The insulating member 6 is formed by a general vacuum film formation technique such as a sputtering method, a CVD method, and a vacuum evaporation method. The thickness thereof is determined from the range of several nm to several μm, and preferably, it is determined from the range of several ten nm to several hundred nm.

By forming a laminated body of three or more insulating layers as an insulating material, it is possible to obtain an effective advantage (an electron beam that is excellent in a focusing capability). Further, according to the present embodiment, it is assumed that a step of FIG. 3B includes a step of forming a second insulating layer with a material having a higher etching rate than a first insulating layer. A difference of the etching rate is produced by a difference of composition (a difference in a component and a doping amount) and a difference of a manufacturing method (a difference in a density and a binding). A step of forming the insulating member 6 by layering three or more insulating layers in this way (namely, by layering the insulating layers 6a to 6c) is a characteristic first step in the present invention.

In a combination of two and more kinds of insulating layers, as an example of a difference of composition, a difference of composition in SiO₂/SiN, SiO₂/Al₂O₃, and other SiON or the like may be considered. In addition, as an example of a difference of a film formation method, SiO₂ that is film-formed by a plasma CVD method/SiO₂ that is film-formed by a sputtering method or the like may be considered.

The gate electrode 4 has a conductive property as well as the cathode electrode 2, and the gate electrode 4 is formed by a general vacuum film formation technique such as an evaporation method and a sputtering method, and a photolithography technique. A material of the gate electrode 4 is accordingly selected from the group consisting of a metal, an alloy metal, a carbide, a boride, a nitride, a semiconductor, and an organic polymer material. As a metal, for example, Be, Mg, Ti, Zr, Hf, V, Nb, Ta, Mo, W, Al, Cu, Ni, Cr, Au, Pt, and Pd or the like may be used, and an alloy metal formed by using these metals is available. As a carbide, TiC, ZrC, HfC, TaC, SiC, and WC or the like may be used. As a boride, HfB₂, ZrB₂, LaB₆, CeB₆, YB₄, and GdB₄ or the like may be used. As a nitride, TiN, ZrN, and HfN or the like may be used. Then, as a semiconductor, Si and Ge or the like may be used.

Next, a mask pattern 31 is formed using a photolithography technique (FIG. 3C).

Then, as shown in FIG. 3D, the gate electrode 4 and the insulating layer 6 are partially removed by using the mask pattern 31. Thereby, on each of the gate electrode and the insulating member, openings to be communicated with each other can be formed. The sizes, the shapes, and the directions (of the shapes) of the openings of the gate electrode and the insulating member, which are provided in this way, are approximately the same with each other. A manufacturing method of these openings may be selected accordingly from the group consisting of a dry etching method, and a wet etching method or the like depending on materials and thicknesses of the gate electrode and the insulating layer. In addition, a partial microfabrication such as a focused ion beam etching may be accordingly selected according to the circumstances.

Next, a mask pattern 31 is peeled off as shown in FIG. 3E.

Then, as shown in FIG. 3F, a desired side wall structure is formed in the opening of the insulating member 6. This step is a characteristic second step of the present invention. Specifically, the opening of the second insulating layer is made larger than the opening of the gate electrode. According to the present embodiment, this step is carried out by using a wet etching method. If this step is carried out by the wet etching method, the openings of the gate electrode 4 and the insulating member 6 are mutually concentric fashion and the directions of the shapes are also approximately the same.

According to the present embodiment, a structure of an effective insulating layer (namely, an insulating layer in order to form an electron-emitting device that is excellent in a focusing property and can be stably driven for a long period of time) will be described.

The first insulating layer (the insulating layer 6c) brought into contact with the gate electrode 4 has two roles.

One is a role as a supporting member of the gate electrode 4. The gate electrode 4 needs the lowest thickness in order to apply an effective potential to the opening. On the other hand, making the thickness of the gate electrode 4 thicker, an opening height h becomes higher and an electron emission efficiency becomes lower. In other words, in order to achieve a balance between the focusing property (focusing capability) and the electron emission efficiency, the gate electrode 4 having an appropriate thickness is desirable. However, in the case that a thickness of the gate electrode 4 is such the thickness, a sufficient mechanical intensity of the gate electrode 4 cannot be obtained. Therefore, in the case where the opening of the first insulating layer (the insulating layer 6c) is larger than the opening of the gate electrode 4, it is feared that the gate electrode 4 is deformed by an electric field to be formed within the opening. Thus, by making the size of the opening of the first insulating layer (the insulating layer 6c) approximately the same as the size of the opening of the gate electrode 4, it is possible to make the gate electrode 4 strong against such a deformation.

Other is a role so as to decrease a leak current to be generated upon driving. Such a leak current may be generated by a residue (an attachment) due to etching attaches to the side wall during forming an opening. In order to remove this, it is effective to etch the surface of the side wall portion. In the case of carrying out this step by using the wet etching method, if the gate electrode has no process resistance (a resistance against etching), the resistance of the gate electrode may be increased or the adhesion of the gate electrode may be lowered. In addition, even if the gate electrode itself has a resistance, when a part of the gate electrode has a pin hall, an etching solution may erode the insulating member from a pin hall portion of the gate electrode. Then, this eroded portion is made into an origin of the leak current (namely, a dielectric strength voltage is lowered). If the first insulating layer (the insulating layer 6c) brought into contact with the gate electrode has a structure having an etching resistance (namely, a material being less soluble in a liquid to be used for etching; a material having a low etching rate), erosion of the etching solution from the upper part of the gate electrode can be prevented, so that generation of the leak current can be prevented.

There are two roles in making the opening of the second insulating layer (the insulating layer 6b) larger than the opening of the gate electrode in FIG. 3F. This will be described by using an example shown in FIG. 3F below.

One is a role to improve a focusing property due to combination with the insulating layer located nearer to the side of the cathode electrode than the second insulating layer (in the example of FIG. 3F, the insulating layer 6a that is the lowest layer). Specifically, by making the size of the opening to be the opening of the insulating layer 6a<the opening of the insulating layer 6b, it is possible to obtain a concave equipotential plane, namely equipotential plane of obtaining an excellent focusing property of an electron beam.

The other is a role to decrease the leak current. In order to prevent the leak current between the cathode electrode and the gate electrode passing via a conductive path around the opening of the gate electrode and the insulating member, a residue (an attachment) adhering to the opening of the insulating member may be removed. By making the insulating member into multiple layers and removing the attachment of any layer, such a leak current can be decreased. Specifically, by solving the surface of any insulating layer by using a wet etching method in a step shown in FIG. 3F, the attachment can be removed. In addition, the dielectric strength voltage of the insulating member is heightened since the creeping distance of the insulating member is made longer due to such a structure.

As described above, by making the insulating member into the multiple layers, it is possible to obtain an electron-emitting device that is excellent in a focusing property and can be stably driven for a long period of time. In order to form such an insulating member, an etching resistance of each layer may be considered so as to have a desired shape by using the wet etching method. Specifically, a material having a higher etching rate than the insulating layer 6a and the insulating layer 6c may be used for the insulating layer 6b.

Further, the electron-emitting device that is configured as described above has a very simple configuration, namely, repetition of layering, so that its manufacturing process is simple and the electron-emitting device can be manufactured with a good yield ratio.

In the example of FIG. 3F, considering the roles of the above-described first insulating layer and second insulating layer, it is possible to determine the structure of the electron-emitting device that is excellent in a focusing property and can be stably driven for a long period of time according to the following method.

At first, thicknesses t1 and t2 of the insulating layer 6a (the third insulating layer; the insulating layer located nearer to the side of the cathode electrode than the second insulating layer) and the insulating layer 6b (the second insulating layer) in order to obtain a sufficient focusing property may be determined.

Then, an opening diameter w2 of the insulating layer 6b is determined. A setback distance (an etching amount) of the insulating layer 6b is also a parameter to influence a focusing property and it is better that the length of the setback distance is longer if the first insulating layer 6a can hold the role as the supporting member sufficiently. Due to this setback distance, the opening diameter w2 may be varied.

On the other hand, the insulating layer 6c is not related to a focusing property so much, so that a material and a thickness thereof may be accordingly decided in consideration of a process resistance.

In this way, an electron-emitting device as shown in FIGS. 1A and 1B is completed.

The size of the opening of the gate electrode (the opening diameter w) is a factor to determine the size of the beam diameter, and if it is about several μm, the smaller the opening diameter is, the smaller the beam diameter becomes. Preferably, the size is in the range of several hundred nm to several ten μm. Further preferably, the size is in the range of 100 nm to 3 μm.

It is also a factor to determine a focusing property that the opening of the gate electrode larger than an area where the electron-emitting member is exposed (namely, an exposed area), specifically, the opening is made larger from the position where the electron-emitting member is provided toward the side where the electrons are emitted. Further, it is also determines a focusing property that each opening of each layer have such shape.

Assuming that the sizes of the all openings are the same, namely, there is no inclination in the opening and the opening being perpendicular to the substrate is an inclined angle of 90 degrees (namely, an angle from the outside of the opening), the opening, of which inclined angle is near to 90 degrees, can be easily manufactured. In the configuration that the inclined angle is more than 90 degrees (namely, an inverse taper configuration), a problem such that attachments adhering to the side wall are increased is easily caused in a manufacturing process.

Therefore, in the manufacturing process, an inclined angle of a general opening is in the range of 45 degrees to 90 degrees. The electron-emitting device can obtain a focusing property that is more excellent than the opening having an inclined angle of 90 degrees by having the inclined opening. However, as described above, in order to obtain an excellent focusing property, it is effective to make the opening diameter smaller. The configuration such that the inclination of the opening is large is equivalent to the configuration such that the opening diameter w is larger, so that it is difficult to produce the electric field and a focusing property is deteriorated. Accordingly, in order to obtain a good electric field distribution within the opening, it is preferable that the inclined angle is in the range not less than 60 degrees to not more than 90 degrees. Further, according to the present embodiment, in the section, two virtual lines connecting the end of the gate electrode with the end of the exposed area of the electron-emitting member so as not to intersect with each other may be considered. Then, an angle from the outside of the opening for the substrate of each virtual line is defined as an inclined angle of the opening.

### <Application>

Applications of the electron-emitting device according to the present embodiment will be described below. The electron-emitting device according to the present embodiment can configure an electron source, for example, by arranging a plurality of electron-emitting devices on the substrate. Then, it is possible to configure an image display apparatus by using this electron source.

As arrangement of the electron-emitting device, various arrangements may be adopted. As an example, a plurality of electron-emitting devices is arranged in an X direction and a Y direction in matrix. One electrodes of the plural electron-emitting devices that are arranged in the same line are connected to a wiring in the X direction in common, and other electrodes of the plural electron-emitting devices that are arranged in the same row are connected to a wiring in the Y direction in common. This is referred to as a simple matrix arrangement. Hereinafter, the simple matrix arrangement will be described in detail.

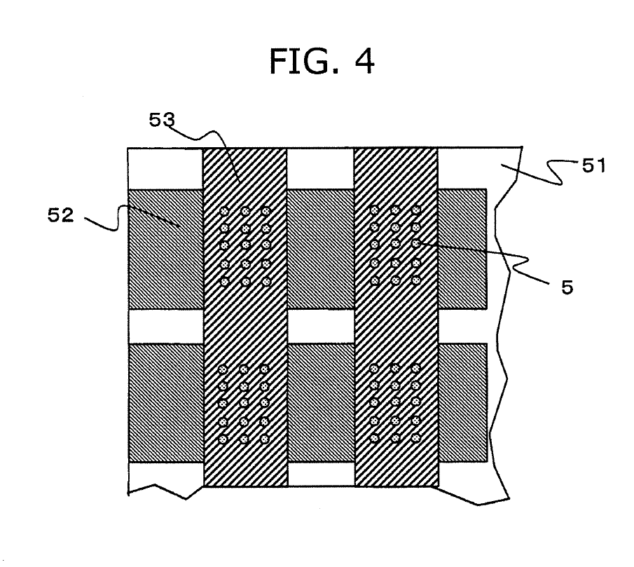

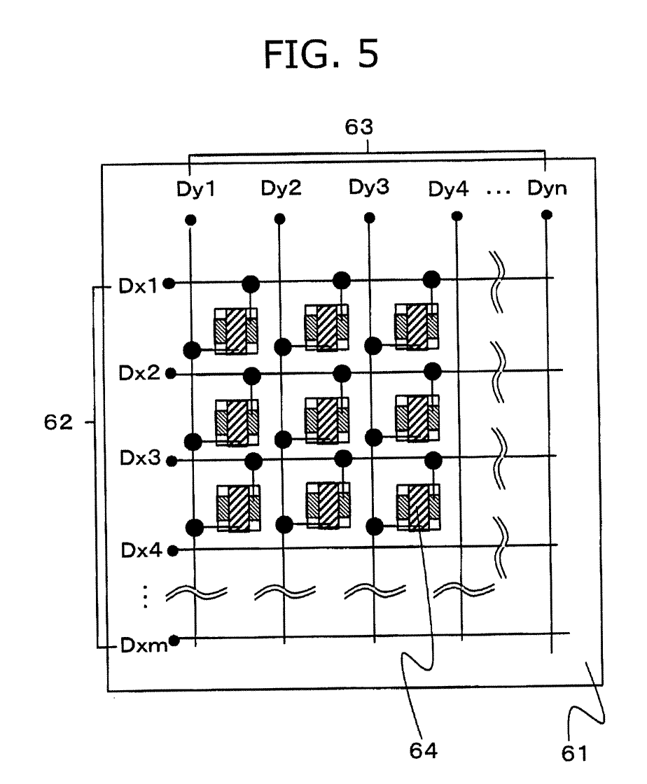

In FIGS. 4 and 5, reference numerals 51 and 61 denote an electron source substrate, reference numerals 52 and 62 denote X-directional wirings, and reference numerals 53 and 63 denote Y-directional wirings. A reference numeral 64 denotes an electron-emitting device according to the present embodiment.

The X-directional wiring 62 is formed by m pieces of wirings, namely, Dx1, Dx2, . . . , and Dxm, and the X-directional wiring 62 can be made of a conductive metal or the like, which is formed by using a vacuum evaporation method, a printing method, and a sputtering method or the like. The material, the film thickness, and the width of the wiring are appropriately designed. The Y-directional wiring 63 is formed by n pieces of wirings, namely, Dy1, Dy2, . . . , and Dyn, and the Y-directional wiring 63 is formed in the same way as the X-directional wiring 62. An inter-layer insulating layer (not illustrated) is provided between these m pieces of X-directional wirings 62 and n pieces of Y-directional wiring 63, and the both wirings are electrically separated (both of m and n are positive integers).

The inter-layer insulating layer (not illustrated) is composed of SiO₂ or the like, which is formed by using a vacuum evaporation method, a printing method, and a sputtering method or the like. For example, the inter-layer insulating layer is formed in a desired shape, on the whole surface or a partial surface of the electron source substrate 61, on which the X-directional wirings 62 are formed. Particularly, the material, the film thickness, and the manufacturing method of the inter-layer insulating layer are appropriately determined so as to be capable of enduring a potential difference in a cross portion between the X-directional wiring 62 and the Y-directional wiring 63. The X-directional wiring 62 and the Y-directional wiring 63 are pulled out as an external terminal, respectively.

The m pieces of the X-directional wirings 62 to configure the electron-emitting device 64 may be also served as the cathode electrode 2. The n pieces of the Y-directional wirings 63 to configure the electron-emitting device 64 may be also served as the gate electrode 4. The inter-layer insulating layer may be also served as the insulating member 6.

To the X-directional wirings 62, a scanning signal applying means (not illustrated) is connected. The scanning signal applying means may apply a scanning signal to the electron-emitting device 64, which is connected to the selected X-directional wiring. On the other hand, to the Y-directional wirings 63, a modulation signal generating means (not illustrated) is connected. The modulation signal generating means may apply a modulation signal, which is modulated in accordance with an input signal, to each row of the electron-emitting device 64. A driving voltage to be applied to each electron-emitting device may be supplied as a difference voltage between the scanning signal and the modulation signal to be applied to an electron-emitting device.

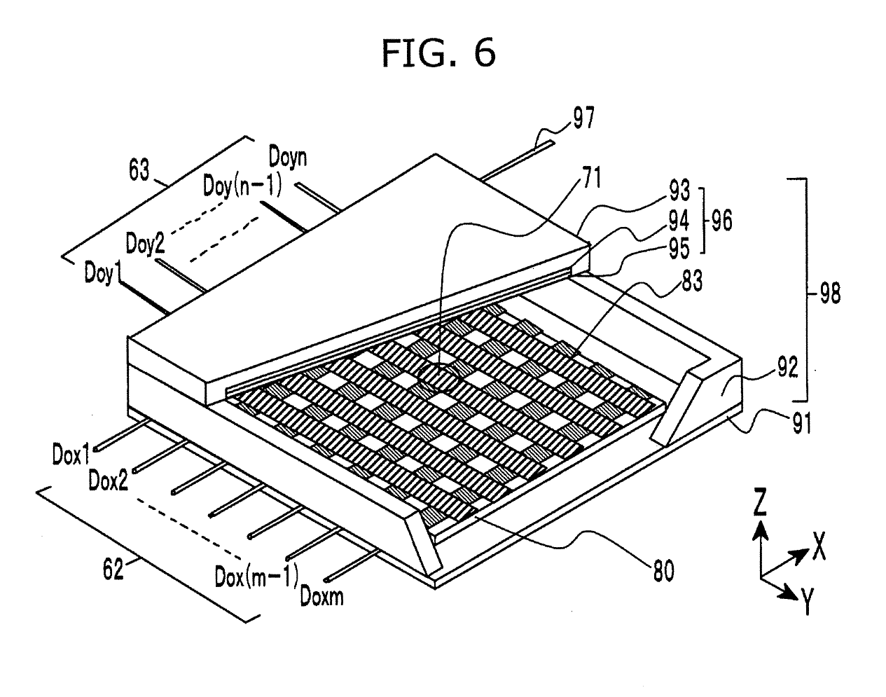

Thus, it is possible to manufacture an electron source having a plurality of electron-emitting devices according to the present embodiment. According to the above-described configuration, by using a simple matrix wiring, an electron-emitting device is individually selected and the selected electron-emitting device can be individually driven. An image display apparatus that is configured by using the above-described electron source will be described with reference to FIG. 6. FIG. 6 is a schematic view showing an example of a display panel of an image display apparatus.

In FIG. 6, a reference numeral 71 denotes an electron-emitting device, a reference numeral 80 denotes an electron-source substrate, a reference numeral 91 denotes a rear plate, a reference numeral 96 denotes a face plate, and a reference numeral 92 denotes a support frame. On the electron-source substrate 80, a plurality of electron-emitting devices 71 is arranged, and on the rear plate 91, the electron-source substrate 80 is fixed. A face plate 96 is formed by a glass substrate 93, a phosphor film 94, and a metal back 95 or the like. The phosphor film 94 and the metal back 95 are provided on the inside of the glass substrate 93. In the example of FIG. 6, on the inside (the inside surface) of the glass substrate 93, the phosphor film 94 is provided, and on the inside of the phosphor film 94, the metal back 95 is provided. To the support frame 92, the rear plate 91 and the face plate 96 are connected by using a flit glass or the like.

A panel 98 is configured by the face plate 96, the support frame 92, and the rear plate 91. The rear plate 91 is provided mainly in order to reinforce an intensity of the electron-source substrate 80, so that, if the electron-source substrate 80 has sufficient intensity, an rear plate 91 is not needed. In other words, the electron-source substrate 80 and the rear plate 91 may be an integrated-configured member.

The face plate 96, the rear plate 91, and the support frame 92 are sealed by applying a flit glass on the face, to which each of them is connected (namely, a bonding surface), positioning them at a predetermined position, fixing them, and heating them to burn the flit glass.

In addition, as method of such heating, various methods such as a lamp by using an infrared lamp or the like and a hot plate or the like can be adopted, however, the present invention is not limited to them.

In addition, a bonding material to heat-bonding a plurality of members for configuring the panel is not limited to the flit glass. Various bonding materials that can maintain a sufficient vacuum condition after a bonding step can be adopted.

The above-described panel is one embodiment of the present invention. The present invention is not limited to the above-described configuration and various configurations can be adopted.

As other example, directly sealing the support frame 92 on the electron-source substrate 80, a panel 98 may be configured by a face plate 96, a support frame 92, and an electron-source substrate 80. The panel 98 having a sufficient intensity against an atmosphere pressure can be configured by providing a supporting member referred to as a spacer between the face plate 96 and the rear plate 91.

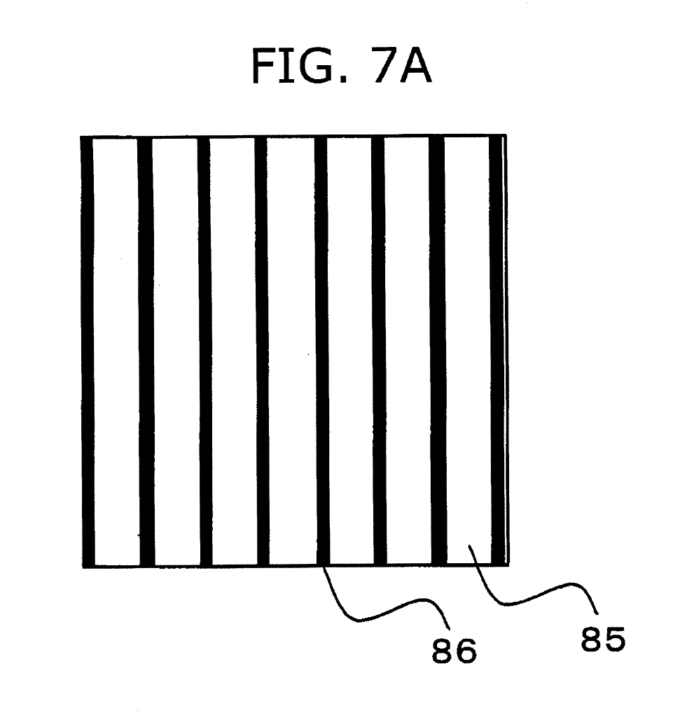

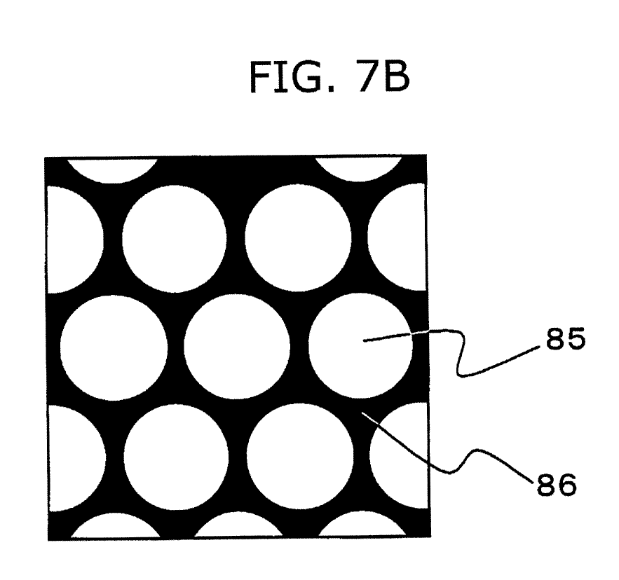

In addition, FIGS. 7A and 7B show a schematic view of the phosphor film 94, which is formed on the face plate 96. The phosphor film 94 is an image forming member to form an image by the electrons, which are emitted from the electron source. In the case of a monochrome phosphor film, the phosphor film 94 can be formed only by a phosphor 85. In the case of a color phosphor film, the phosphor film 94 can be formed by a black conductive material 86, which is referred to as a black stripe (FIG. 7A) and a black matrix (FIG. 7B) or the like and the phosphor 85.

There are two objects to provide the black stripe and the black matrix. The first object is to minimize a mixed color or the like by making a color-coded part between respective phosphor 85 of necessary three original colors into black, in color display. Then, the second object is to prevent lowering of a contrast due to a reflection of an outside light in the phosphor film 94. As a material of the black stripe, other than a generally-used material that is mainly composed of a black lead, a material having a conductive property and small transmission and reflection of a light can be used.

As a method for applying a phosphor on the glass substrate 93, a precipitation method and a printing method or the like can be adopted despite monochrome or color. On the inner face side of the phosphor film 94, normally, the metal back 95 is provided. There are three objects to provide a metal back, and one of them is to improve brightness by specular-reflecting a light to the inner side of the group consisting of light emissions of the phosphor to the side of the face plate 96. Then, to effect the metal back as an electrode to apply an electron beam acceleration voltage and to protect the phosphor film 94 from a damage due to collide of a negative ion that is generated within the panel or the like are also the objects to provide the metal back. The metal back 95 can be manufactured by carrying out smoothing processing of the surface on the inner face side of the phosphor film (normally, referred to as “filming”) after forming a phosphor film and then, accumulating Al by using a vacuum evaporation or the like.

On the face plate 96, in order to heighten the conductive property of the phosphor film 94, a transparent electrode (not illustrated) may be provided (on the outside surface side of the phosphor film 94).

In the image display apparatus according to the present embodiment, the electron-emitting device 71 emits electron beams straight up, so that the phosphor film 94 is arranged just above the electron-emitting device 71.

Next, a vacuum sealing step in order to vacuum-seal a panel having a sealing step applied will be described.

In the vacuum sealing step, at first, while heating the panel 98 and maintain it at 80 to 250° C., the panel 98 is exhausted by an exhaust system such as an ion pump and a sorption pump through an exhaust pipe (not illustrated). Then, after making atmosphere into atmosphere having a sufficiently-small organic substance, the panel 98 is completely sealed by heating and solving the exhaust pope by a burner. In order to maintain a pressure after sealing the panel 98, getter processing may be carried out. This is a processing to heat a getter that is arranged at a predetermined position (not illustrated) within the panel 98 by using a resistance heating or a high frequency heating or the like just before carrying out vacuum sealing of the panel 98 or after sealing and forming an evaporation film. Normally, the getter contains Ba or the like as a main component. Due to an absorption action of this evaporation film, the atmosphere within the panel 98 is maintained.

According to the image display apparatus having an electron source of a simple matrix arrangement that is manufactured by the above steps, a voltage is applied to each electron-emitting device via extra-container terminals Dox1 to Doxm and Doy1 to Doyn. Thereby, electrons are emitted from each electron-emitting device.

By applying a high voltage to the metal back 95 or a transparent electrode (not illustrated) via a high voltage terminal 97, an electric beam is accelerated.

By the accelerated electron collides into the phosphor film 94, a light emission is generated and an image is formed.

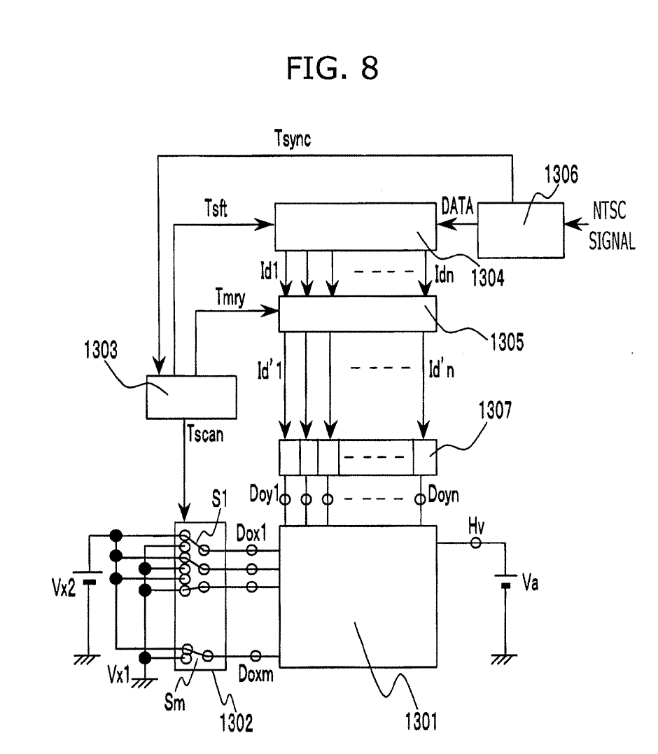

FIG. 8 is a block diagram showing an example of a driving circuit in order to display an image using a TV signal of an NTSC system.

A driving circuit of FIG. 8 will be described. This circuit is provided with M pieces of switching devices (S1 to Sm) there within. Respective switching devices may select an output voltage of a direct current voltage source Vx1 or a direct current voltage source Vx2 to be electrically connected to the extra-container terminals Dox1 to Doxm of a display panel 1301. Respective switching devices S1 to Sm may be operated based on a control signal Tscan, which is outputted from a control circuit 1303, and for example, respective switching devices S1 to Sm can be configured by combining switching devices such as FET. A direct voltage source Vx1 is determined based on a property of an electron-emitting device.

The control circuit 1303 has a function to match the operations of respective parts so that appropriate display is made based on an image signal to be inputted from the outside. The control circuit 1303 may output respective control signals Tscan, Tsft, and Tmry to respective parts based on a synchronization signal Tsync to be transmitted from a synchronization signal separating circuit 1306.

The synchronization signal separating circuit 1306 is a circuit for separating a synchronization signal component and a luminance signal component from a TV signal (an NTSC signal) of an NTSC system to be inputted from the outside and the synchronization signal separating circuit 1306 can be configured by using a general frequency separating (filter) circuit or the like. A synchronization signal that is separated from the NTSC signal by the synchronization signal separating circuit 1306 is composed of a vertical synchronization signal and a horizontal synchronization signal, however, these synchronization signals are illustrated here as a DATA signal for convenience of explanation. This DATA signal is inputted in a shift register 1304.

The shift register 1304 serves to serial/parallel convert the DATA signal to be inputted serially in a chronologic order for each line of an image. A DATA signal is converted based on a control signal Tsft to be transmitted from the control circuit 1303. In other words, it can be said that the control signal Tsft is a shift clock of the shift register 1304. The data for one line of the image that is serial/parallel converted (equivalent to the driving data for N pieces of the electron-emitting devices) is outputted as N pieces of parallel signals Id1 to Idn to be inputted in the line memory 1305.

The line memory 1305 is a storage unit for storing the data for one line of image only for a necessary time, and the line memory 1305 may accordingly store the contents of Id1 to Idn in accordance with the control signal Tmry to be transmitted from the control circuit 1303. The stored contents are outputted as Id′1 to Id′n to be inputted in a modulation signal generator 1307.

The modulation signal generator 1307 is a signal source of a modulation signal for accordingly driving and modulating each of the electron-emitting devices according to the present embodiment in response to each of the image data Id′1 to Id′n. The output signal from the modulation signal generator 1307 is applied to the electron-emitting device in the display panel 1301 through terminals Doy1 to Doyn.

In the case of applying a pulse voltage to the electron-emitting device, for example, even if the voltage not more than the electron-emitting voltage is applied, the electrons are not emitted, however, if the voltage not less than the electron-emitting voltage is applied, the electrons are emitted. In this case, it is possible to control the intensity of the electron-beam to be outputted by changing a crest value Vm of the pulse. In addition, it is also possible to control a total amount of charges of the electron beams to be outputted by changing a width of a pulse Pw.

Accordingly, as a system for modulating an electron-emitting device in response to an input signal, a voltage modulation system and a pulse width modulation system or the like can be adopted. As a voltage modulation system, a circuit, which generates a voltage pulse with a predetermined length as the modulation signal generator 1307 and accordingly modulates a crest value of a pulse in response to the data to be inputted, can be used.

As a pulse modulation system, a circuit, which generates a voltage pulse with a predetermined crest value as the modulation signal generator 1307 and accordingly modulates a width of a voltage pulse in response to the data to be inputted, can be used.

As the shift register 1304 and the line memory 1305, a digital signal system or an analog signal system can be adopted because serial/parallel conversion and storage of an image signal may be carried out at a predetermined rate.

In the case of using the digital signal system, it is necessary to convert the output signal DATA of the synchronization signal separating circuit 1306 into digital signals. In other words, in the case of using the digital signal system, an A/D converter may be provided on the output portion of the synchronization signal separating circuit 1306. In this connection, the circuit to be used for the modulation signal generator 1307 may be slightly different depending on whether the output signal of the line memory 1305 is a digital signal or an analog signal. Specifically, in the case of the voltage modulation system using the digital signal, a D/A conversion circuit may be used as the modulation signal generator 1307 and if necessary, an amplifier circuit or the like may be added thereto. In the case of the pulse width modulation system, as the modulation signal generator 1307, a circuit combining a high speed oscillator, a counter for counting the number of waves to be outputted by this oscillator, and a comparator for comparing an output value of the counter with an output value of a line memory may be used. If necessary, an amplifier for amplifying the modulation signal having a modulated pulse width to be outputted from the comparator up to the driving voltage of the electron-emitting device may be added thereto.

In the case of the voltage modulation system using the analog signal, as the modulation signal generator 1307, for example, an amplifier circuit using an operational amplifier can be adopted. If necessary, a level shift circuit or the like may be added thereto. In the case of the pulse width modulation system, for example, a voltage control-type oscillation circuit (VCO) can be adopted. If necessary, an amplifier for amplifying a voltage up to the driving voltage of the electron-emitting device according to the present invention may be added thereto.

The above-described configuration of the image display apparatus is an example of an image display apparatus to which the present invention can be applied, and based on a technical spirit of the present invention, various modifications can be made. As the input signal, not limited to the NTSC system, a PAL system, a SECAM system, and a TV signal (a high-definition television, for example, a MUSE system) system composed of more scan lines than these systems may be adopted.

In addition, other than the display apparatus, the present image display apparatus can be also used as an image display apparatus or the like as an optical printer configured by using a photosensitive drum or the like.

Hereinafter, the examples of the present invention will be described in detail.

### FIRST EXAMPLE

A specific example of a manufacturing method of an electron source of FIG. 4 having a plurality of electron-emitting devices as shown in FIGS. 1A and 1B will be described as a first example according to the present embodiment.

### (Step 1)

At first, a PD 200 glass was used as the substrate 1. After sufficient cleaning, as the cathode electrode 2, Ta with a thickness 800 nm was formed.

### (Step 2)

Next, using a mask material, the electron-emitting member 5 of a diamond-like carbon was accumulated on a desired place about a thickness 30nm by a plasma CVD method. After that, the mask material was removed. As a reaction gas, a CH₄ gas was used.

### (Step 3)

Further, as the insulating member 6, Si₃N₄ (the insulating layer 6a) of a thickness 400 nm, SiO₂ (the second insulating layer; the insulating layer 6b) of a thickness 300 nm, and Si₃N₄ (the first insulating layer; the insulating layer 6c) of a thickness 300 nm were accumulated in order.

In addition, as a comparative example, as the insulating member 6, SiO₂ of a thickness 1 μm was also manufactured at the same time.

Further, as the gate electrode 4, Pt of a thickness 100 nm was accumulated.

### (Step 4)

Further, by using a photolithography method, the mask pattern 31 of a resist was formed. In the present example, an UV cure processing is carried out to a resist material in order to harden the resist material.

### (Step 5)

Next, using the mask pattern 31 as a mask, the gate electrode 4 of Pt was partially removed by an Ar plasma etching. Further, the insulating layers 6a to 6c were partially removed by a dry etching using a CF₄ gas, respectively.

### (Step 6)

Then, the mask pattern 31 is peeled off and sufficient cleaning was carried out. Here, a resistance between the cathode electrode and the gate electrode was measured by a tester. Both of the electron-emitting device according to the present example and the electron-emitting device according to the comparative example had resistance values of 100 kΩ due to a process residue.

### (Step 7)

Next, a wet etching was carried out using a buffered fluorinated acid of HF:NH₃F=1:16. For this solution, an etching rate of SiO₂ (the insulating layer 6b) was 50 nm/minute. This etching rate was higher than an etching rate of Si₃N₄ (the insulating layer 6a; the insulating layer 6c) and it was not less than SiO₂: Si₃N₄=100:1.

By controlling the concentration of the etching solution and the etching time, as the side wall structure of the insulating member, various structures can be manufactured. In the electron-emitting device according to the present example, the insulating layer 6b only has a higher etching rate for the solution to be used for etching, so that the opening of the insulating layer 6b was configured so as to be larger than the openings of the insulating layer 6a and the insulating layer 6c as shown in FIG. 3F. In addition, in the electron-emitting device of the comparative example, the opening of the entire insulating member was larger than the opening of the gate electrode.

In the electron-emitting device according to the present example, the opening was formed approximately vertical (an inclined angle 90 degrees). Specifically, w=3 μm=w1=w3, and w2=6 μm.

Here, the electron-emitting device according to the present example and the electron-emitting device according to the comparative example were observed. In the both, on the upper part of the gate electrode 4, there was change of the shape due to the manufacturing process such as an etching. In addition, in the electron-emitting device according to the comparative example, the partial peeling off of the gate electrode 4 was generated, however, in the electron-emitting device according to the present example, no such a partial peeling off of the gate electrode 4 was generated.

This is because, in the electron-emitting device according to the comparative example, an adhesiveness of the gate electrode is deteriorated and the gate electrode is partially peeled off since the etching solution of (Step 6) erodes SiO₂ of the insulating member 6 from a pin hall of the gate electrode formed above the insulating member 6. In the electron-emitting device according to the first example, a generation frequency of the pin hall of the gate electrode 4 was the same as that of the comparative example, however, Si₃N₄ of the third insulating layer 6c was not eroded and no peeling off of the gate electrode occurred.

Further, the resistances between the cathode electrodes and the gate electrodes of these electron-emitting devices were measured by using a tester. In the both of the first example and the comparative example, the resistances were not less than 100 MΩ and there was no decrease of resistance due to a process residue.

As described above, the electron-emitting device according to the first example and the electron-emitting device according to the comparative example were arranged as shown in FIG. 2, respectively, where H=2 mm and Va=10 kV, and Vg=50 V.

Here, by using an electrode having a phosphor as the anode electrode 7, the size of the electron beam was observed. The size of the electron beam in this case is a size of an area where a brightness value of the light-emitted phosphor is not less than 10% of a peak value.

An electron emission efficiency of the electron-emitting device according to the first example was in the range of 0.5 to 0.9, and in the electron-emitting device according to the comparative example, the electron-emitting device was in the range of 0.1 to 0.5.

This is because, in the electron-emitting device according to the comparative example, a part of the exposed area of the electron-emitting member 5 is located just below the gate electrode 4 and an electric field just below the gate electrode is strong, so that it seems that the electrons are easily emitted from this position. Specifically, the electron emitted from just below of the gate electrode 4 enters the gate electrode 4, so that a current passes between the cathode electrode and the gate electrode. Therefore, it seems that the reactive current is increased and the efficiency is lowered. In the electron-emitting device according to the present example, the electron-emitting member 5 is not located just below the gate electrode 4 but it is exposed within the opening of the gate electrode. Further, in the electron-emitting device according to the present example, it seems that the efficiency is heightened since, due to an effect of a focusing potential configuration formed by the insulating layers 6a and 6b, there are very few electrons to enter the gate electrode.

The beam diameter of the electron-emitting device according to the first example was 75% of the beam diameter of the electron-emitting device according to the comparative example, so that a focusing property thereof was excellent. In addition, in only the electron-emitting device according to the comparative example, spread of the beam having a brightness ratio that was less than 1% of the highest brightness, is observed around a main beam.

This is because, in the electron-emitting device according to the comparative example, some of the electrons entering the gate electrode 4 are emitted again through dispersion to reach the anode electrode, so that a beam with a lower brightness is observed around the main beam.

Further, the electron-emitting device according to the present example and the electron-emitting device according to the comparative example had been driven for ten hours. As a result, in the electron-emitting device according to the comparative example, the electrons are easily emitted just after driving, however, after that, the deteriorated electrons-emitting devices were generated. Picking up the electron-emitting devices according to the comparative example and observing them, some of them have the gate electrode bent within the opening in the vicinity of the opening.

Further, after driving of the electron-emitting device for ten hours, the increase rate and the generation frequency of the leak current were measured. In the electron-emitting device according to first example, the generation frequency of a electron-emitting device that the leak current was 10% or more than a leak current just after the driving was 20% of the electron-emitting device according to the comparative example.

### SECOND EXAMPLE

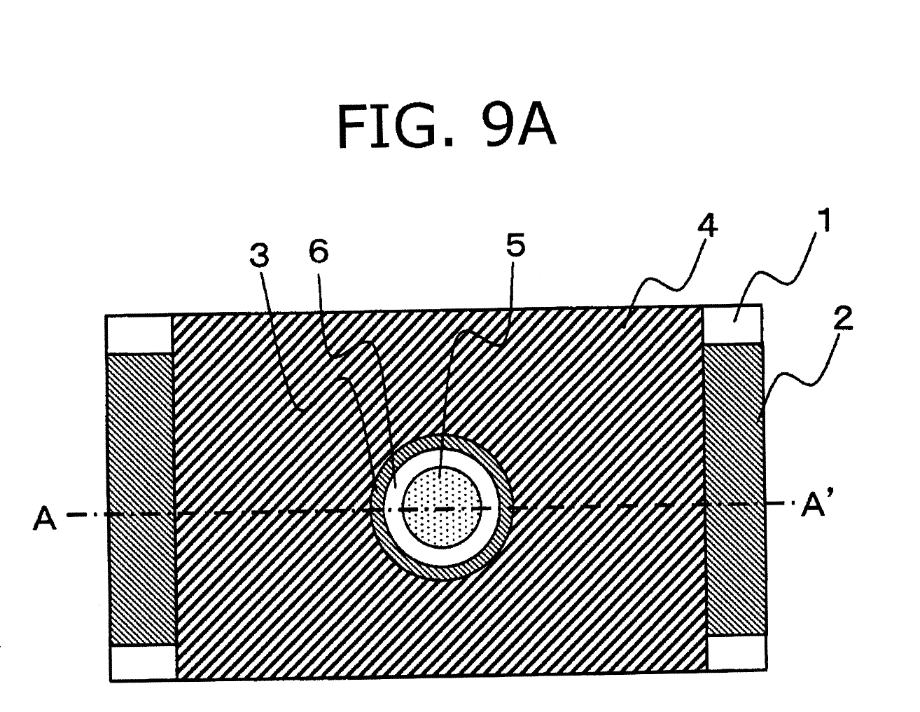

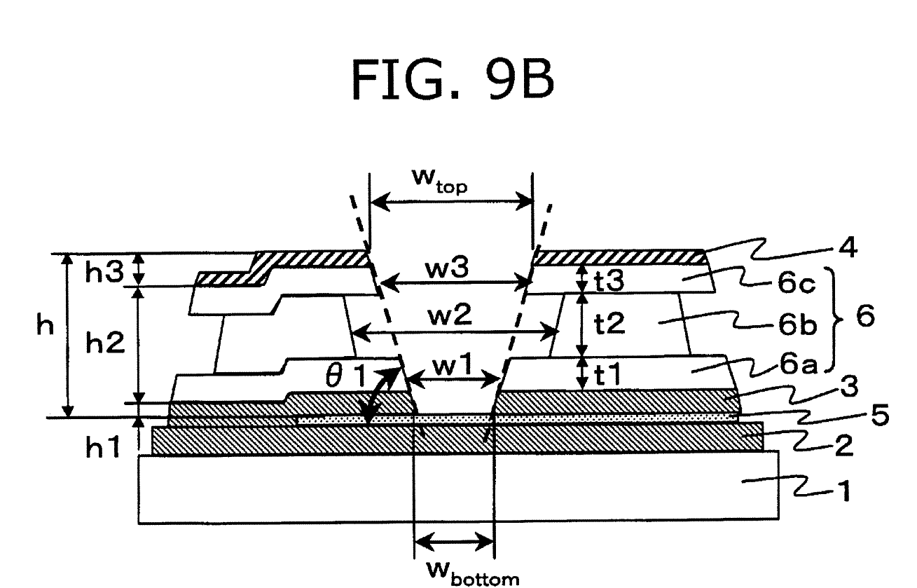

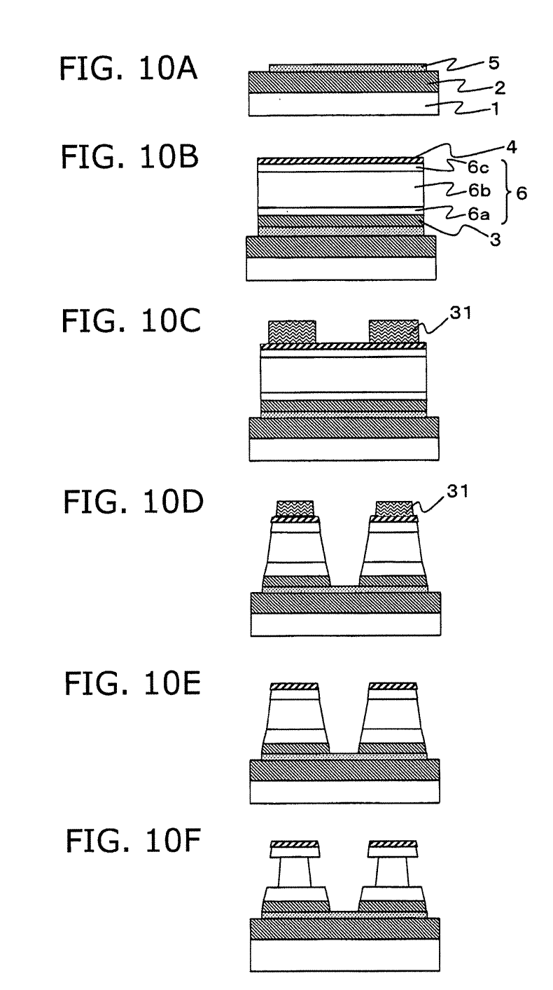

FIGS. 9A and 9B show an electron-emitting device according to a second example. The present example shows an example such that there is inclination in the opening (namely, an example that the opening of the gate electrode is larger than the exposed area of the electron-emitting member). FIG. 9A is a plan view and FIG. 9B is a sectional view taken on a line A-A′ in FIG. 9A. FIGS. 10A to 10F show a manufacturing method of the electron-emitting devise according to the present example, respectively.

### (Step 1)

At first, as the substrate 1, a PD 200 glass was used. After sufficient cleaning, as the cathode electrode 2, Ta with a thickness 800 nm was formed.

### (Step 2)

Next, using the mask material, the electron-emitting member 5 of a diamond-like carbon was accumulated on a desired place about a thickness 30 nm by a plasma CVD method, by. After that, the mask material was removed. As a reaction gas, a CH₄ gas was used (FIG. 10A).

### (Step 3)

Then, on the electron-emitting member, as the second electrode 3, Ta of a thickness 100 nm was layered. Further, on the second electrode, as the insulating member 6, Si₃N₄ (the insulating layer 6a) of a thickness 300 nm, SiO₂ (the insulating layer 6b ; the second insulating layer) of a thickness 500 nm, and Si₃N₄ (the insulating layer 6c; the first insulating layer) of a thickness 200 nm were accumulated in order. Further, as the gate electrode 4, Pt of a thickness 100 nm was accumulated (FIG. 10B). The second electrode 3 is electrically connected to the cathode electrode 2, and by providing such a second electrode 3, it is possible to manufacture an electron-emitting device that is excellent in a focusing property.

### (Step 4)

Further, by using a photolithography method, the mask pattern 31 of a resist was formed (FIG. 10C).

The resist shape was defined to be a rectangle shape. In the first example, the UV cure processing is carried out to the resist material in order to harden the resist material, however, in the second example, the UV cure processing was not carried out thereto.

### (Step 5)

Using the mask pattern 31 as a mask, the gate electrode 4 of Pt is partially removed by an Ar plasma etching. Further, the insulating layers 6a to 6c and the second electrode 3 were partially removed by a dry etching using a CHF₃ gas or CHF₃+O₂ gas, respectively (FIG. 10D).

By adding an oxygen gas, the etching can be progressed with the opening being inclined.

### (Step 6)

Peeling off the mask pattern 31, sufficient cleaning was carried out (FIG. 10E).

### (Step 7)

Next, a wet etching was carried out using a buffered fluorinated acid of HF:NH₃F=1:16.

In the present example, it was possible to manufacture the electron-emitting device configured as shown in FIG. 10F for a shorter etching time than the first example.

In the electron-emitting device according to the present example, the inclined angle θ1 of the opening was 75 degrees. In addition, wbottom=3 μm, wtop=3.6 μm, w1=3 μm, w2=4 μm, and w3=3.5 μm were established, and h=1.2 μm, h1=0.1 μm, h2=1 μm, and h3=0.1 μm were established. In addition, t1=0.3 μm, t2=0.5 μm, and t3=0.2 μm were established.

According to the present example, the focusing property is given from three configurations. One of them is the shapes of the insulating layers 6a and 6b shown in the first example. Further, according to the second example, the focusing property of the beam is intensified due to arrangement of the second electrode 3 on the upper face of the electron-emitting member and the inclined angle of the opening.

Further, according to the second example, the focusing property can be controlled by the film thickness of the second electrode, so that the backward amount of the insulating layer 6b is enough if it can achieve a balance between decrease of the leak current and an effect (function) as a supporting member rather than securing of the focusing property. In other words, according to the first example, it is necessary to make the backward amount of the insulating layer 6b larger in order to obtain the focusing property, however, according to the second example, the electron-emitting device with a high focusing property can be manufactured even if the backward amount of the insulating layer 6b is smaller than the first example. Thereby, electron-emitting device according to the second example has a higher stability than electron-emitting device according to the first example, and can obtain the same focusing property as electron-emitting device according to the first example.

### THIRD EXAMPLE

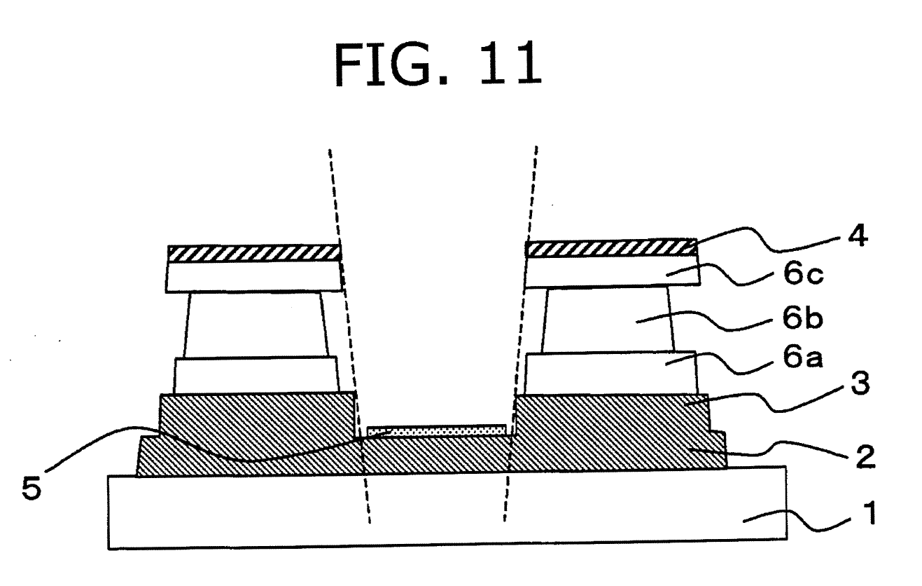

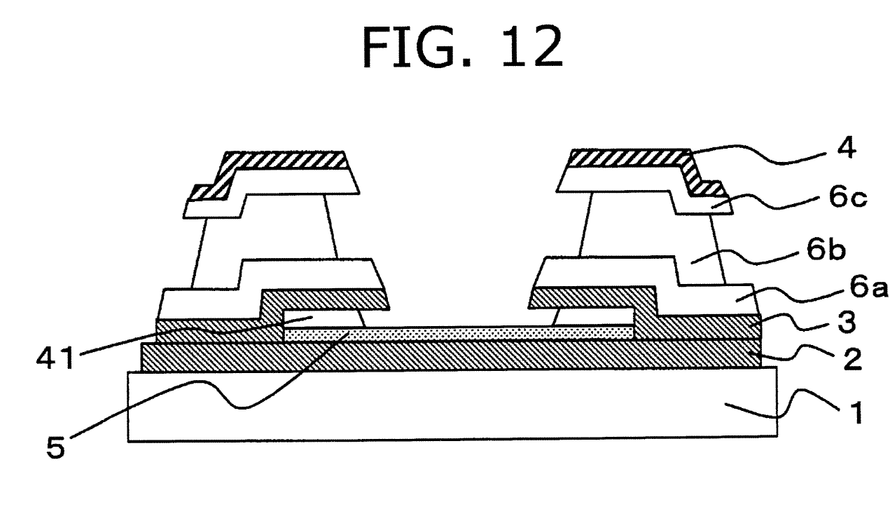

FIG. 11 shows an electron-emitting device according to the third example. Hereinafter, a manufacturing method of an electron-emitting device according to the present example will be described.

### (Step 1)

At first, as the substrate 1, PD 200 was used. After sufficient cleaning, as the cathode electrode 2, TiN with a thickness 650 nm was formed.

### (Step 2)

Further, as the insulating member 6, SiON (the insulating layer 6a) of a thickness 100 nm, SiO₂ (the insulating layer 6b; the second insulating layer) of a thickness 800 nm, and Si₃N₄ (the insulating layer 6c; the first insulating layer) of a thickness 100 nm were accumulated in order. Further, as the gate electrode 4, Pt of a thickness 100 nm was accumulated.

### (Step 3)

Further, by using a photolithography method, the mask pattern 31 of a resist was formed.

### (Step 4)

Using the mask pattern 31 as a mask, the gate electrode 4 of Pt was partially removed by an Ar plasma etching. The insulating member 6 was partially removed by a dry etching using a CHF₃+O₂ gas. The cathode electrode 2 of TiN was partially removed by a dry etching using a BCl₃ gas up to a depth 150 nm. In this time, the inclined angle of the opening was 85 degrees.

### (Step 5)

Next, using a hot filament CVD method, the electron-emitting member 5 of a diamond-like carbon was accumulated about a thickness 50 nm. As a reaction gas, a CH₄ gas was used. The electron-emitting member was accumulated on the mask and the cathode electrode 2 in order to apply a bias voltage to the substrate.

### (Step 6)

Next, the electron-emitting member on the gate electrode was peeled off together with the resist mask to be removed.

### (Step 7)

Next, a wet etching was carried out using a buffered fluorinated acid. Thereby, the insulating layer 6b went back and SiON of the insulating layer 6a slightly went back. This is because the etching rate is SiO₂>SiON>Si₃N₄. In this time, the residue due to the dry etching adhering to the side wall of the opening and the residue of the electron-emitting member were removed together with the insulating layers 6a and 6b. In other words, due to this step, in the section of the electron-emitting device, the insulating member was located outside of a quadrangle having two virtual lines connecting the end of the opening of the gate electrode and the end of the exposed area of the electron-emitting member as two sides. This section is a section that is obtained by a flat surface that is perpendicular to the gate electrode and passes through centers of openings of the gate electrode and the insulating member. Due to such a configuration, a creeping distance can be more increased, so that the leak current can be more reduced.

According to the present example, the cathode electrode 2 and the second electrode 3 according to the second example are formed by one cathode electrode 2. In other words, also in the present example, the same effect of a case that the cathode electrode 2 and the second electrode 3 according to the second example are connected so as to have the same potentials can be obtained.

According to the present example, by forming the film of the electron-emitting member 5 after forming the opening, the electron-emitting area can be limited within the opening. In addition, selecting the materials having a good adhesiveness for the cathode electrode and the protection layer, it is possible to reinforce a device structure. In addition, by forming the electron-emitting member after forming the opening, a deterioration of a process upon manufacturing of the opening may not be considered, so that a range of selection of the electron-emitting member is widened.

On the other hand, in the case of forming the electron-emitting member after formation of the opening, the electron-emitting member easily remains within the opening and this generates the leak current. However, by partially removing the insulating layer by etching as the present example, the leak current due to the electron-emitting member can be also reduced.

### FOURTH EXAMPLE

FIG. 12 shows an electron-emitting device according to the fourth example. The present example relates to a configuration having a protection insulating layer 41 on a part of the electron-emitting member. However, it is assumed that this protection insulating layer 41 is not included in the insulating layer to form the insulating member.

### (Step 1)

At first, as the substrate 1, PD 200 was used. After sufficient cleaning, as the cathode electrode 2, Tin with a thickness 500 nm was formed.

### (Step 2)

Next, using the mask material, the electron-emitting member 5 of a diamond-like carbon was accumulated on a desired place about a thickness 30 nm by a plasma CVD method. Then, as the protection insulating layer 41, SiO₂ of a thickness 50 nm was accumulated. After that, the mask material was removed.

### (Step 3)

Further, as the second electrode 3, Tin of a thickness 70 nm was accumulated. Further, as the insulating member 6, Si₃N₄ (the insulating layer 6a) of a thickness 400 nm, SiO₂ (the insulating layer 6b; the second insulating layer) of a thickness 300 nm, and Si₃N₄ (the insulating layer 6c; the first insulating layer) of a thickness 300 nm were accumulated in order. Further, as the gate electrode 4, Tin of a thickness 100 nm was accumulated.

### (Step 4)

Further, by using a photolithography method, the mask pattern 31 of a resist was formed.

### (Step 5)

Using the mask pattern 31 as a mask, the gate electrode 4 of TiN was partially removed by a dry etching with a BCl₃ gas. The insulating member 6 was partially removed by a dry etching with a CF₄ gas. The second electrode of TiN was partially removed by a dry etching with a BCl₃ gas.

### (Step 6)

Peeling off the mask pattern 31, sufficient cleaning was carried out.

### (Step 7)

Next, a wet etching was carried out using a buffered fluorinated acid. Thereby, the protection insulating layer 41 was removed and the electron-emitting member was exposed within the opening. In addition, the insulating layer 6b went back.

The present example is different from other examples in that a focusing configuration is formed by the protection insulating layer and the second electrode, however, other effects are the same. By using the protection insulating layer 41, it is prevented that the electron-emitting member is exposed during the manufacturing process, so that it is possible to prevent deterioration of the electron-emitting member.

### FIFTH EXAMPLE

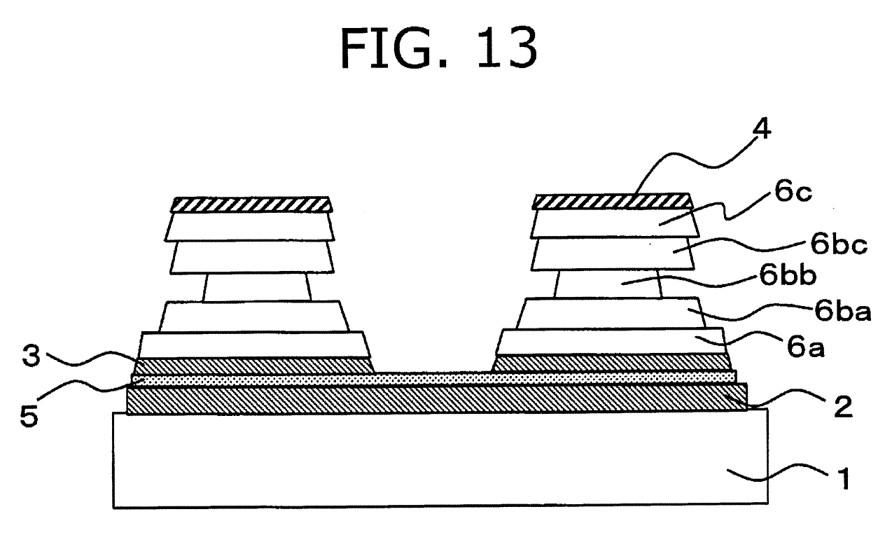

FIG. 13 shows an electron-emitting device according to the fifth example.

A manufacturing method of an electron-emitting device according to the present example is the same as that of the electron-emitting device according to the second example as shown in FIG. 9, however, the configuration of the insulating member 6 is different from the second example. Specifically, the insulating member 6 according to the present example is configured by five insulating layers. In other words, the electron-emitting device according to the present example has three second insulating layers.

As the insulating member 6, Si₃N₄ (the insulating layer 6a), SiON (an insulating layer 6ba; the second insulating layer), SiO₂ (an insulating layer 6bb; the second insulating layer), SiON (an insulating layer 6bc; the second insulating layer), and Si₃N₄ (the insulating layer 6c; the first insulating layer) are accumulated. This layering was carried out using a plasma CVD method by changing a film formation condition such as a used gas and a power for each insulating layer. Here, the thickness of the insulating layer 6a is 100 nm, the thickness of the insulating layer 6ba is 200 nm, the thickness of the insulating layer 6bb is 400 nm, the thickness of the insulating layer 6bc is 200 nm, and the thickness of the insulating layer 6c is 100 nm.

According to the present configuration, by increasing the number of the insulating layers, it is possible to define a distribution of an electric field with a higher accuracy.

### SIXTH EXAMPLE

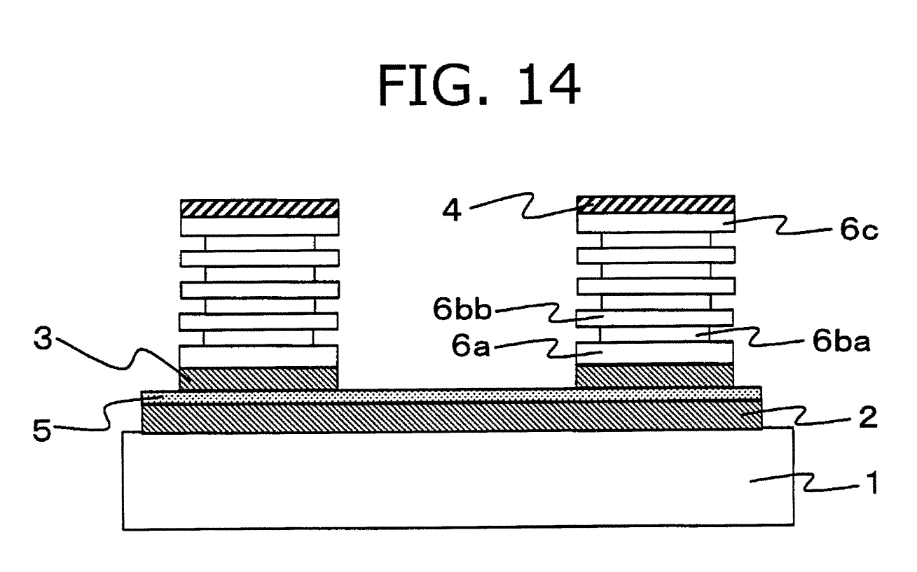

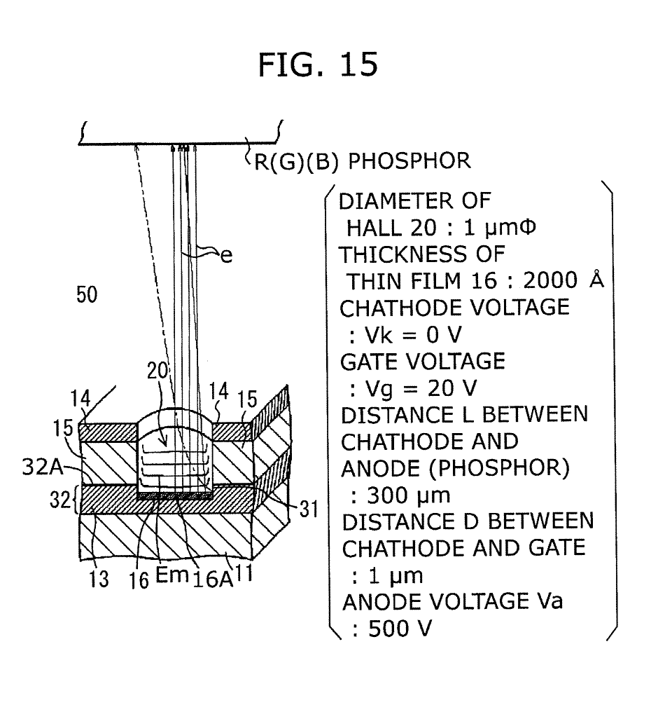

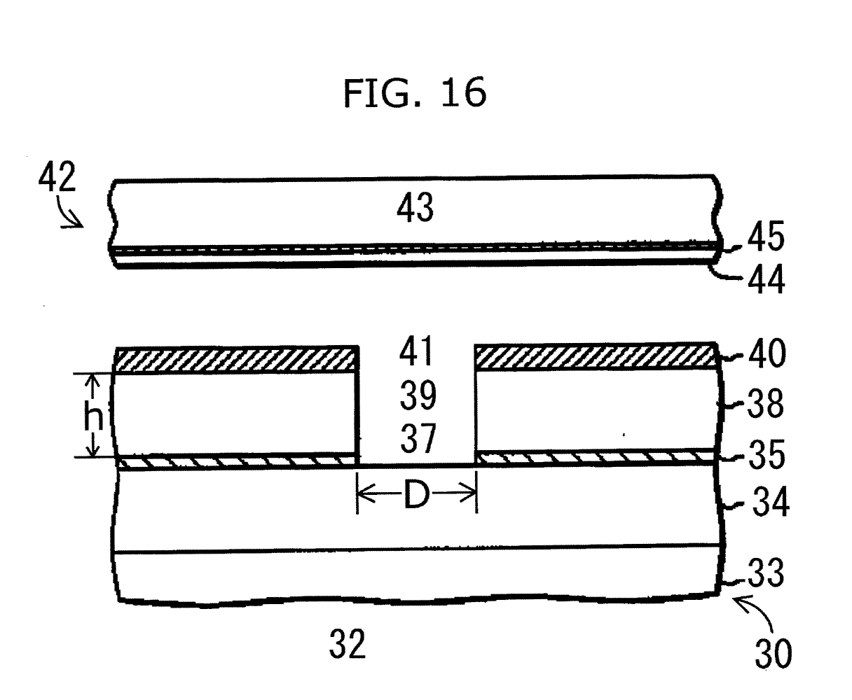

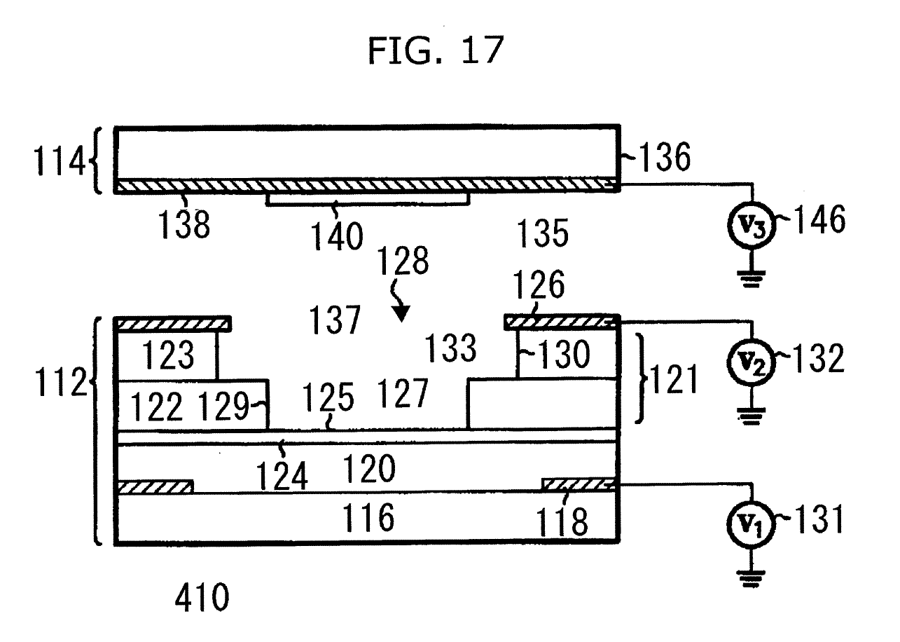

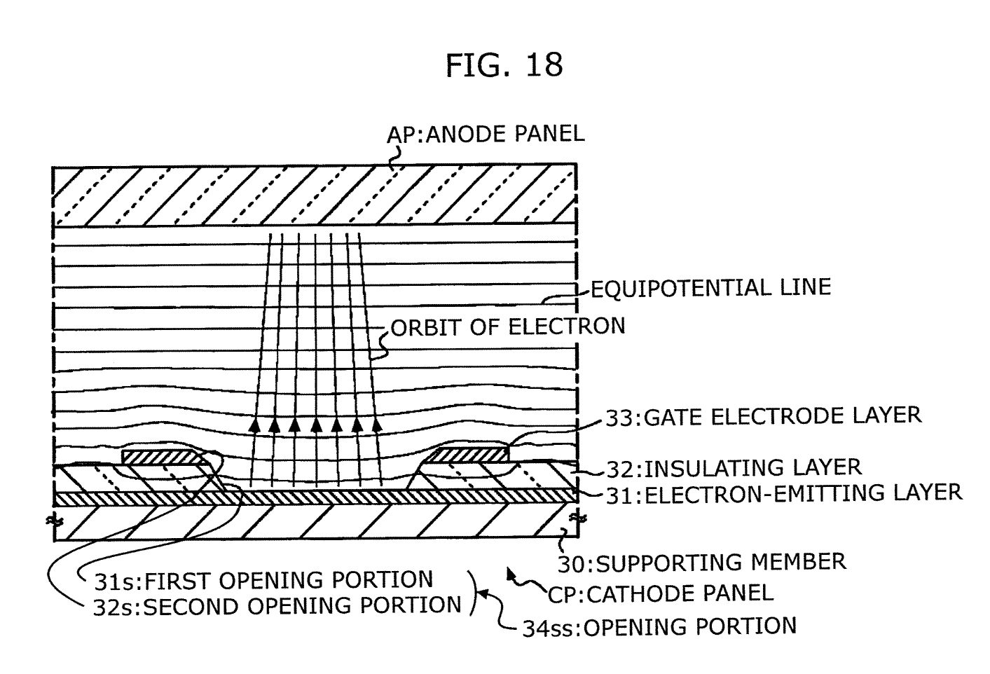

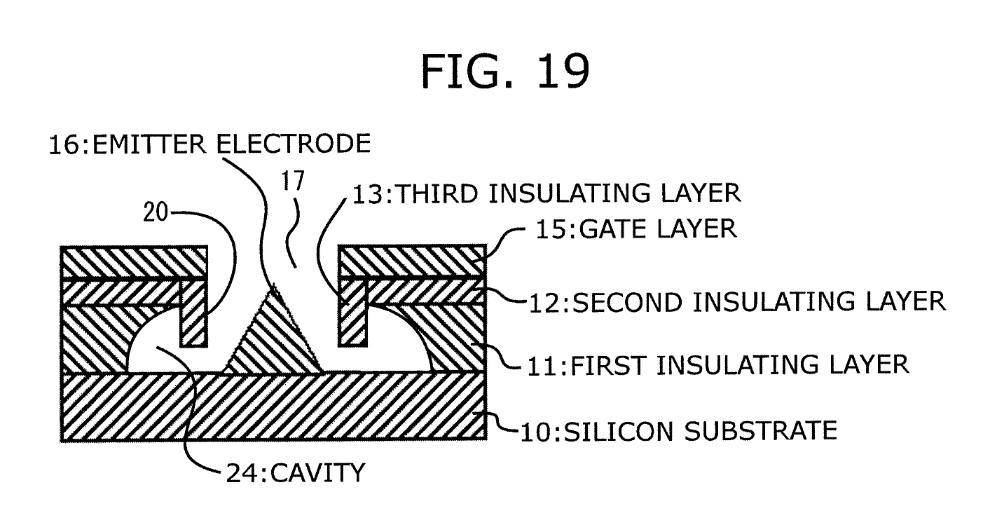

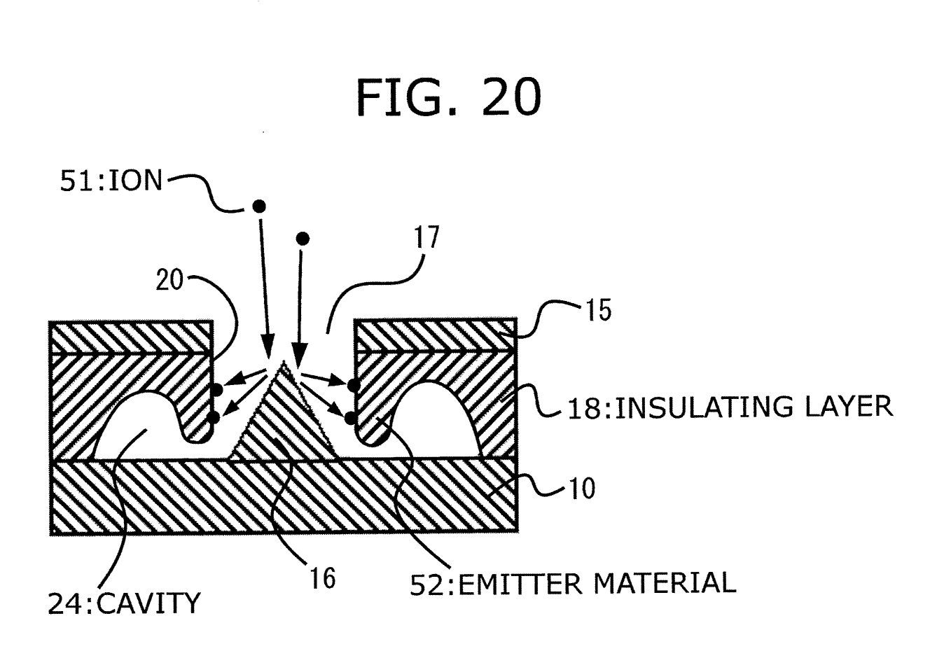

FIG. 14 shows an electron-emitting device according to the sixth example.

According to the present example, on the second electrode 3, a plurality of different insulating layers is layered alternately.

The configuration of the insulating member 6 (a formation method) will be described. At first, as the lowest layer, Al₂O₃ of a thickness 250 nm (the insulating layer 6a) was accumulated. Then, on this layer, accumulation of SiO₂ (the insulating layer 6ba; the second insulating layer) of a thickness 70 nm and Si₃N₄ (the insulating layer 6bb; the second insulating layer) of a thickness 70 nm were alternated repeatedly in three times. Further, by layering SiO₂ (the insulating layer 6ba; the second insulating layer) of a thickness 70 nm and Al₂O₃ of a thickness 250 nm (the insulating layer 6c; the first insulating layer), the insulating member 6 was formed. Respective layers were accumulated in order using a sputtering method.

Formation of the opening was made by a dry etching, and for etching of Al₂O₃, an Ar plasma etching was used.

For a wet etching, a buffered fluorinated acid was used, however, Al₂O₃ was not etched.

As a result, by changing a condition of an etching step, an electron-emitting device shown in FIG. 14 can be formed.

According to the present electron-emitting device, Al₂O₃ having a high dielectric strength voltage was used as an insulating layer, so that a generation amount of the leak current was smaller compared to the electron-emitting device according to the second example. In addition, according to the present example, the creeping distance between the cathode electrode and the gate electrode can be made larger, so that the withstanding pressure of the insulating layer can be made higher, and a stability of driving for a long period of time was improved.

### SEVENTH EXAMPLE

Next, an example of the configuration, which is the same as that of the first example and has the reversed composition of the insulating member, will be described.

As the insulating member 6, SiO₂ (the insulating layer 6a) of a thickness 400 nm, Si₃N₄ (the insulating layer 6b; the second insulating layer) of a thickness 300 nm, and SiO₂ (the insulating layer 6c; the first insulating layer) of a thickness 300 nm were accumulated in order.

The opening is formed by a dry etching using CF₄.

For a wet etching, a hot phosphoric acid was used. Thereby, Si₃N₄ was etched but SiO₂ was not etched.

As the present example, by changing the etching solution, the configuration of the insulating layer can be changed. If the order of SiO₂ and Si₃N₄ is reversed from that of the first example, a difference of the both dielectric constants influences the distribution of the electric field, however, according to the present example, an effect of the shape such that the second insulating layer 6b went back is larger that that influence, so that an effect of a focusing potential such that the equipotential plane is recessed in the vicinity of the cathode electrode can be maintained. In addition, if the etching solution is changed in this way, the insulating layer just below the gate electrode can be changed, so that, as the material of the gate electrode, a material with a high adhesiveness can be also selected.

As described above, the electron-emitting device according to the present embodiment is an electron-emitting device, of which electron beam diameter is small and driving thereof is stable. By applying such an electron-emitting device to an electron source and an image display apparatus, it is possible to realize an electron source and an image display apparatus having high performance.

According to the present embodiment, the size of the opening of each of three insulating layers to form an insulating member is described in detail, however, it is obvious that a diameter of an electron beam can be made smaller if the dielectric constant of each of three insulating layers is devised.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions, This application claims the benefit of Japanese Patent Application No. 2007-280201, filed on Oct. 29, 2007, which is hereby incorporated by reference herein in its entirety.

What is claimed is:

1. An electron-emitting device comprising: a cathode electrode, a gate electrode, an insulating member, and an electron-emitting member;
wherein the gate electrode is located above the cathode electrode;
the insulating member is located between the gate electrode and the cathode electrode;
the gate electrode and the insulating member are provided with openings, respectively, the openings being communicated with each other; and
the electron-emitting member is provided on the cathode electrode, and at least a part of the electron-emitting member is exposed within the openings of the gate electrode and the insulating member,
wherein the insulating member is formed by layering three or more insulating layers including a first insulating layer, which is brought in contact with the gate electrode and has an opening, of which size is approximately the same as the size of the opening of the gate electrode; and a second insulating layer, which is located nearer to the side of the cathode electrode than the first insulating layer and has a larger opening than the opening of the gate electrode.

2. An electron-emitting device according to claim 1,
wherein the second insulating layer is an insulating layer, which is located in midway of a group consisting of the three or more insulating layers.

3. An electron-emitting device according to claim 1,
wherein, in a section, which is obtained by a flat surface that is perpendicular to the gate electrode and passes through centers of openings of the gate electrode and the insulating member, the insulating member is located outside of a quadrangle having two virtual lines connecting the end of the opening of the gate electrode and the end of an exposed area of the electron-emitting member as two sides.

4. An electron-emitting device according to claim 1,
wherein the opening of the gate electrode is larger than the exposed area of the electron-emitting member.

5. An electron-emitting device according to claim 1,
wherein a second electrode is provided between the electron-emitting member and the insulating member, which is electrically connected to the cathode electrode.

6. An electron-emitting device according to claim 1,
wherein the second insulating layer is made of a material having a higher etching rate than that of the first insulating layer.

7. A manufacturing method of an electron-emitting device, the electron-emitting device comprising: a cathode electrode, a gate electrode, an insulating member, and an electron-emitting member;
wherein the gate electrode is located above the cathode electrode;
the insulating member is located between the gate electrode and the cathode electrode;
the gate electrode and the insulating member are provided with openings, respectively, the openings being communicated with each other; and
the electron-emitting member is provided on the cathode electrode, and at least a part of the electron-emitting member is exposed within the openings of the gate electrode and the insulating member;
the manufacturing method comprising:
a first step of forming the insulating member by layering three or more insulating layers including a first insulating layer, which is brought in contact with the gate electrode; and a second insulating layer, which is located nearer to the side of the cathode electrode than the first insulating layer; and
a second step of making the opening of the second insulating layer larger than the opening of the gate electrode.

8. A manufacturing method of an electron-emitting device according to claim 7,
wherein the first step includes a step of forming the second insulating layer with a material having a higher etching rate than that of the first insulating layer; and
the second step is a step of carrying out wet etching for the three or more insulating layers.

9. An electron source comprising a plurality of the electron-emitting devices according to claim 1.

10. An image display apparatus comprising:
the electron source according to claim 9; and
an image forming member for forming an image by electrons that are emitted from the electron source.
